(19) United States
(12) Patent Application Publication
(10) Pub. No.: US 2008/0189162 A1
(43) Pub. Date: Aug. 7, 2008

(54) System to establish and maintain intuitive command and control of an event

(76) Inventors: Ray Ganong, Oakville (CA); Dennis Hamilton, Milton (CA)

Correspondence Address: GOWLING, LAFLEUR HENDERSON LLP, ONE MAIN STREET WEST, HAMILTON, ON, L8P 4Z5, omitted

(21) Appl. No.: 11/907,972

(22) Filed: Oct. 19, 2007

Related U.S. Application Data
(60) Provisional application No. 60/853,037, filed on Oct. 20, 2006.

(51) Int. Cl. G06Q 10/00; G01C 21/00

(52) U.S. Cl. 705/9; 705/7; 701/300

(57) ABSTRACT

A web-based and phone-based emergency management software system operating as an Intuitive Command and Control application comprised of a number of integrated software-driven functional processes, common communications devices and services, and an enterprise database of key emergency-necessitated information; interactively serving an organization's first responders, administrators and agents, emergency management teams and a number of other key internal and external stakeholders.

### BACKGROUND OF INVENTION

Experiences of the terrorist attacks on Sep. 11, 2001, the devastating tsunami of 2005, the 2007 shootings at a Virginia University and hundreds of other global crises clearly indicated that lives could have been saved, corporations' Brand Image could have been protected and operational disruption could have been minimized with an automation-supported command and control capability.

The complexity arises from the challenges associated with managing vast volumes of information; responding to facts of an event versus rumors, speculation and assumptions; coordinating the efforts of what could be hundreds or even thousands of stakeholders, public authorities and interested parties; executing time-sensitive responses/actions based on changing conditions; the resulting impact of in-crisis decisions; and applying consistent and timely communications to all stakeholders.

The SARS epidemic in the spring of 2003 hit many parts of the world, including North America, killing hundreds of people and closing down dozens of businesses. At the time, many companies did not completely realize that if one employee in an office contracts the disease, the local public health authorities have the legal right and obligation to quarantine every person within that facility and the facility itself. With less than one hour of advance notice, an entire organization, regardless of size or relative importance, could be brought to an abrupt and complete standstill. The impact and experiences of the SARS epidemic could be manifested hundreds of times over with an Avian Flu Pandemic and according to the World Health Organization, an impending threat to the world.

Emergency Response Management Services Corporation (ERMS), armed with over 20 years of emergency and crisis management consulting experience with hundreds of private and public sector organizations, determined that ‘software’ could be developed to address the challenges stated and reduce the failures that have yet to be experienced, but will undoubtedly occur.

### SUMMARY OF INVENTION

The software (the invention, generally referred to as ERMS) is designed to provide four highly integrated processes; (1) Intuitive Command and Control processes managing the innate relationship of the software to an event and the stakeholders who are impacted by or responding to that event; (2) the construct and maintenance of a complex Operational Mask, the databases providing vital information necessary in a response; (3) the management and employment of the technology & telecommunications infrastructure utilized by the software in response to an event and (4) the functional processes (features) of the software as described in Features of Invention.

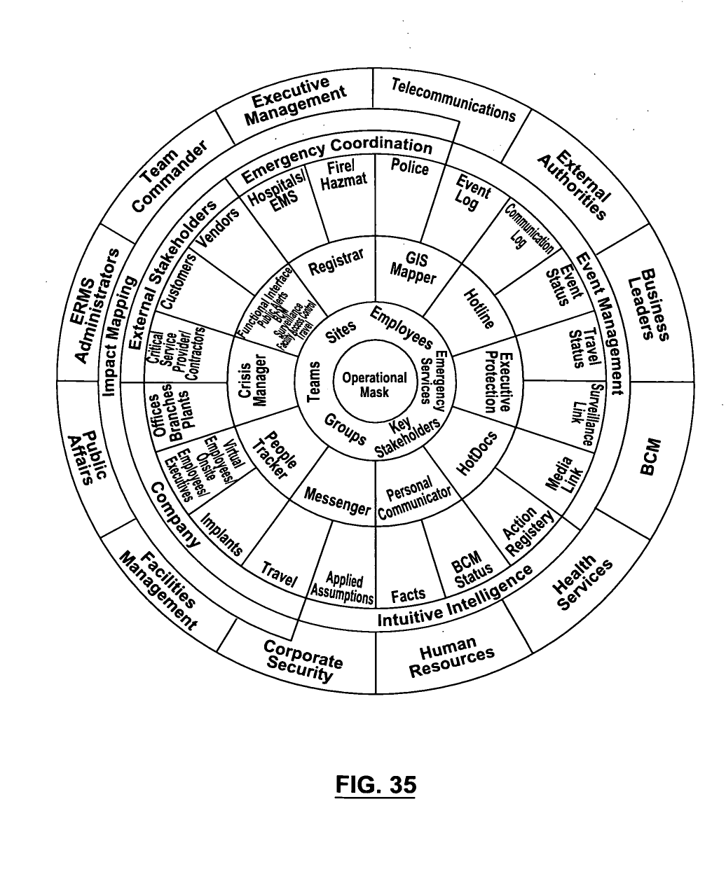

### Intuitive Command and Control (ICC)—Depicted in FIG. 35

The ICC is comprised of interactive and interrelated processes that allow an organization to manage an event from a single point of control, utilize the software features as required and coordinate all aspects of an in-crisis response.
Based on the impact of an event, the actions already taken and possible/probable in-crisis action-trigger points, the ICC ensures responders take essential steps necessitated by the event or alternatives that may not have been considered due to what could be a confusing and chaotic situation.
The ICC provides automatic coordination of first responders applying critical event-conditions to ensure a coordinated response through information sharing, action-driven communications and interactive reporting of actions taken or pending.
Issuance of critical information through a variety of communication devices to key stakeholders based on predefined conditions and on need-to-know criteria is coordinated through the interrelations determined within the event driven ICC.
Access to the software features and functionality by an organization's response Administrators and Agents is coordinated through the capabilities inherent within the ICC.
Automated links to external or internal data sources/systems are provisioned from within the software and managed through the interconnectivity of the ICC ensuring access to live feeds of vital information.
The utilization of key technology resources required to accomplish communications and other functionality are inherent within the software and managed through the interoperability of the ICC, ensuring uninterrupted response and control throughout an event.

### Operational Mask

The ERMS Operational Mask (OM) is a complex relational database that is utilized by all functional processes of the software and is central to an organization's response and recovery efforts, including:
monitoring a threat or event (emergency, disaster or crisis),
measuring impact to determine response,
assessing the impact of an event (life safety, brand image, operations),
accounting for stakeholders (employees, contractors, on-site guests),
searching for missing, displaced or geographically remote stakeholders,
tracking key stakeholders through GPS cell phones, vehicles and other devices,
authenticating participating stakeholders,
the assignment of required resources (people, organizations, teams and groups) to predefined or undetermined tasks,
provisioning of site status information/instructions for employees, customers, suppliers,
safety, protection of executives and other key resources,
provisioning of vital information to first responders and authorities,
management of critical in-crisis processes (notifications, event logs, status reports),
the dissemination of vital information to stakeholders,
provisioning of response required documentation (emergency plans, blue-prints),
interfacing to other response driven systems (technology recovery, business continuity).

The OM maps an organization's physical and logical entities (sites, teams, groups) as well as external organizations deemed critical (3^{rd} party service providers, customers, suppliers, emergency services, authorities, regulators, government services, etc.).

The OM superimposes resources, action plans and static communications (holding statements) to every possible response situation through templates (models) of previous events, regularly occurring events or high-impact threats to ensure a rapid in-crisis response.

The OM provides stakeholder and site profiles, extensive stakeholder contact information and vital in-crisis response scenarios to various entities within the databases.

The OM maintains validity and data integrity through automated time-sensitive interfaces to internal and external information systems ensuring profiling and contact information is utilized without fear of erroneous decision making.

### Summary of Implementation and Utilization Design

The ERMS software is at the heart of providing the most comprehensive fully hosted web-based emergency management service available.

Fundamental components of the service are:
ERMS applications software (the invention),
the internet,
hosting and storage services of a third party,
telephony services of a telecommunications provider.

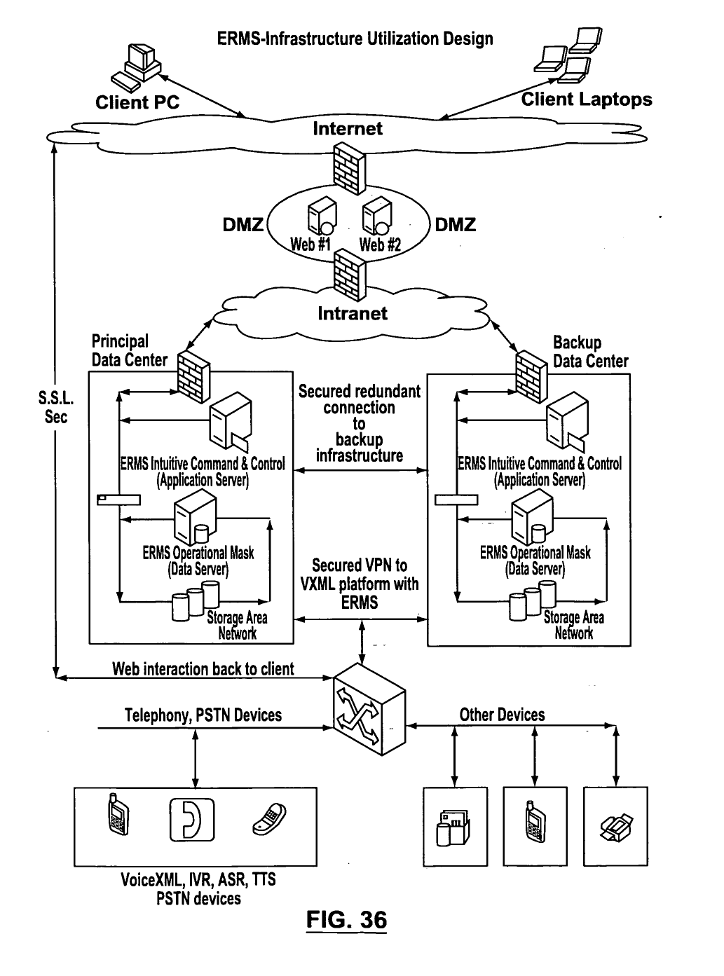

FIG. 36 presents this complex integration of products and services that are functionally managed by and through the software to ensure an organization can focus entirely on their response to a crisis. Full provisioning of the service is accomplished through ERMS functionality as evidenced through the Intuitive Command and Control capability.

### Summary of Features

1. The ERMS system enables an organization to build a sophisticated Operational Mask within the application which contains unlimited groups and subgroups as well as the distinction between physical locations, logical locations, teams, contact groups and individual stakeholders. This advanced site structure capability enables targeted communications.
2. The ERMS system can create a “virtual crisis command center” which enables communication and coordination of large teams. Alerts can be sent to all relevant team members via all standard devices (phone, email, PDA, pager, SMS, Fax) asking individuals to log into an online situation center where they can communicate and collaborate through integrated communications tools such as conference bridging, instant messaging, secure online chat, presence management and push-button publishing. “Workflow” is built into the application, enabling task assignment and automatic task status updates.
3. The ERMS system handles the delivery of the message to the various devices. The initiator of a notification or alert selects the recipients (from the Operational Mask) and focuses on the message, either in text or voice recording; the ERMS system will distribute the message in the appropriate format to the various recipient devices.
4. The ERMS system enables role based backups where stakeholders designate back-up members to take their place should they be unable to play their designated role within a team or group. The system will automatically escalate any notifications to the appropriate designated contacts until an affirmative confirmation has been received.
5. The ERMS system enables the set-up of multiple communications scenarios through the use of customizable templates. Organizations can anticipate possible events and ensure they are properly prepared with one or multiple broadcast scenarios for each scenario complete with pre-defined contact lists and pre-recorded messages.
6. The ERMS system integrates with 3^{rd} party business continuity planning (BCP) software programs, facility access control systems (security cards), audio and video surveillance systems and travel planning applications. Integration with 3^{rd} party applications strengthens the overall command and control of an emergency situation or event.
7. The ERMS system generates automatic real-time reporting which captures high level statistics as well as the ability to drill down for more detailed information. Any number of criteria can be reported on through standard and customized exporting of data for reporting. Some examples include reports which identify the current physical locations of each employee and a record of who requires assistance at any given moment. Other reports might capture real-time findings from surveillance uplinks.
8. The ERMS system provides an un-editable electronic log of all actions taken during an event which can be used to meet government and industry regulatory requirements and assist with post-event audits.
9. Organization-specific data—such as location of the company sites and facilities—can be geo-coded into the ERMS application, such that physical entities of interest to the organization can be reflected on a map.
10. The ERMS system can send geographically targeted communications to various types of stakeholders defined by the organization, including employees, citizens and customers.
11. Automated external map overlays of live events can be imported into the ERMS application. Examples of live events include hurricane and storm tracking.
12. The ERMS system can automate integration of external map overlays from organizations such as the Center for Disease Control and Prevention (CDC), National Weather Service (NWS) and the World Health Organization (WHO) to track trends and developments. Concerns such as disease patterns, environmental impacts and weather patterns can be tracked.
13. Mapping of key authorities and service organizations (e.g., Hospitals, Police, Fire Dept., FEMA, and Red Cross) of interest to an organization can significantly improve the response of an organization when an event requires contacting external service organizations.
14. The ERMS system can capture and analyze GIS based indicators that may be harbingers of imminent crisis situations. This information is then automatically layered on top of our representation of an organizational structure in order to facilitate auto-notifications. The initiations of these notifications are defined via the ERMS interface by the organization and may include, but are not limited to, proximity to projected hurricane paths, earthquake epicenters, forest fires, tornado warnings, civil unrest, flood plains, winter storms, and areas impacted by heightened homeland security alert levels.
15. The ERMS system supports the analysis of GIS based information in the context of emergency management. It allows a user to view and manipulate data as it relates to their organizational structure. This data allows for more informed decisions to be made during the execution of a crisis response. Integration with our backbone of contact information allows for quick response by way of mass communication to stakeholders who may be impacted by the situation. Data may include current and forecasted weather, traffic conditions, airport delays, population density and proximity to emergency services.
16. The ERMS system allows users to gain location coordinates of their stakeholders by way of GPS devices. Communications can be triggered as stakeholders move in and out of areas deemed to be high-risk by ERMS agents. This functionality allows for more accurate recipient targeting with stakeholders during time and location sensitive situations. Response to crisis situations may also differ if accurate stakeholder impact data is available.
17. The ERMS system can locate and account for employees and on-site guests. Employees and on-site guests are able to call in to report their current status and indicate if they require further assistance.
18. The ERMS system can conduct an “employee search” in which a message is sent out requesting employees and on-site guests to report their status.
19. The ERMS Registrar system provides the detailed information about the stakeholders that are reporting to the applicable Registrar.
20. Various categories can be established by an organization to account and report on the responses of the stakeholders. For example, an organization may want to categorize employee responses as follows: ‘Not OK’, ‘Resolved’, ‘No Call Yet Received’, ‘OK’, ‘Responded but Not Qualified’ and ‘Not Assigned/Other’. Beside each category is a number of stakeholders in that category.
21. For each specific category defined by the organization, the ERMS system displays a list. The summary list shows the stakeholder name, time of call and a check mark if the stakeholder response is in a desired outcome such as a ‘Resolved’ category. Each stakeholder name is a link that can be selected to view more information, including individuals that have participated but are not part of the stakeholder database, such as: visitor records.
22. The ERMS system provides detailed information for each stakeholder including their current contact information from their profile record. If the stakeholder left a voice message, there is a selectable ‘Play’ button to hear the message. Below the audio controls, there is a link to mark this person as ‘Resolved’ so that no further action is required on behalf of the organization. There is a log entry area where details of actions taken by the organization can be entered.
23. The ERMS system provides a ‘Not Qualified’ category containing the stakeholders that have called in to report their status for a site but were not included in the stakeholder types for which the Registrar was configured.
24. The ERMS system provides a ‘Not Assigned’ category containing the stakeholders that have called in to report their status for a site which they were not specifically able to identify through the site options. These stakeholder messages are pooled and displayed in all active Registrars until manually assigned to a specific Registrar.
25. The ERMS system provides the option for exporting the current status of the Registrar for downloading to a local computer. The text file is created in a comma-delimited format and can be saved to a computer via the browser.
26. The ERMS system provides an option to record money loaned by the organization to an employee during a crisis. This data is entered in the log file for each stakeholder/employee. The Money Advanced report shows totals of any money loaned and the associated beneficiary stakeholders.
27. At various times during a Registrar event, an organization may want to have ERMS reach out and try to contact those users that have not reported in yet. These times are usually pre-determined according to company policy. The people that have not reported in will be contacted to request that they report. Through this iterative process, the system will contact the individuals that have not yet called as quickly as possible.
28. The ERMS system allows the Registrar Auto Notifications options to be set via the Region Manager functionality. The message notification can be turned “On” with the selection of the individuals who will receive notifications when new visitor voice messages arrive on the inbound telephone line.
29. The individuals identified in the Region Manager for sites defined in the Operational Mask receive an email when individuals start reporting in when a Registrar has not yet been set up. This is an early indication to the organization that a Registrar event may need to be established. The Registrar can be back-dated to automatically include all individuals that have reported since the established start time of the Registrar event.
30. The ERMS system provides a single point of control to leave critical information or status messages through an inbound company phone line. Real-time organization status (Hotline) messages (text or voice) can be recorded through the ERMS application by stakeholders with privileges so that stakeholders calling in can listen to the information/status messages associated with their sites of interest.
31. The ERMS system allows an agent to record an instant message and attach it to any organizational structure via the inbound capability. This function allows a stakeholder to obtain real-time organizational status with a voice message.
32. For the entire ERMS system, there is a default status message. This message is played to the requesting stakeholder when no specific status message exists for a particular entity in the organization's Operational Mask. This message is set up via the Default Message option of the ERMS system. When a message has expired, the specific status message can be simply deleted and the default message will be played the next time a status report is requested by a stakeholder.
33. Global Introduction messages can be defined when there is a situation that affects a large proportion of the stakeholder population. This message will play immediately after the service name for an organization. An example of this type of message would be to announce instructions related to a pending hurricane that could impact many sites and stakeholders.
34. Introduction messages can be defined for each Delivery Region. If the organization uses a separate inbound access number for each region within an organization, then each number can have a distinct introduction message that is played before any other information is presented to the user over the phone.
35. ERMS stakeholders have the capability to review any Hotline messages through PDA devices.
36. Agents with privilege have the capability to create and attach a message to any organizational structure through the use of PDA's.
37. Stakeholders calling into Hotline can request a live attendant at the organization's option.
38. The ERMS system enables individual personal emergency broadcast to a pre-designated list of contacts. In one phone call, a message can be sent to everyone on the individual's personal contact list. Confirmation of receipt acknowledgement is passed back to the initiator for each active contact within the list of contacts.
39. When an organization employs Personal Communicator functionality, then each stakeholder has the option to view and edit their personal contacts. For each contact, a name and two phone numbers are entered with an indication whether the contact is active. The ERMS Administrator defines how many contacts, to a limit of 99, are permitted with Personal Communicator.
40. When a stakeholder dials the ERMS inbound access number, a menu option is offered to send a Personal Communicator message. The system prompts for a digital voice (DV) message to be recorded. Once the stakeholder is satisfied with the recording, they can press 1 or say “Save” to direct the system to send the message to all personal contacts.
41. A stakeholder can send a Personal Communicator message via the web browser. The PDA web interface also offers the option to send a Personal Communicator message. These typed messages are sent using TTS (text to speech) technology to the phone numbers specified for each contact.
42. Detailed reporting can provide the number of minutes used by each Personal Communicator user.
43. A predefined number of minutes can be made available to the Personal Communicator user.
44. The ERMS system provides secure, web-based access to crisis related content. Permissions to view and access documentation is set up by the administrator and documents are stored to map back to the organization's Operational Mask.
45. The ERMS system searches through all of the organization's documents (with filters) to find a word or chain of characters, providing a result list of all matched documents.
46. To group related documentation, the software employs document categories to narrow the search. Documents can be attached or linked to a specific entity within the organization's Operational Mask. The ERMS Agent or Administrator will typically categorize documentation into 5-10 categories to allow for effective filtering when searching for documents using the keyword search facility.
47. Privileges to upload or download documents are granted separately and are limited to defined portions of the Organizational Mask.
48. ERMS provides a method for dialing extensions in buildings that use that type of phone system. The phone number for the main automated attendant is entered under the Primary Phone number for the site. A mask is then entered, which is essentially a string of characters that instruct ERMS how to dial the numbers.
49. The regular place of work for each stakeholder is defined by their site membership. Each stakeholder must have at least one primary ‘home’ site within the organization's Operational Mask.
50. A Stakeholder Type is used to specify what types of contact information are available. For instance, a Stakeholder Type of ‘Employee’ could have Home Phone 1 set to ‘Required’ but a ‘Customer’ Stakeholder Type could have the Home Phone 1 field set to ‘Off’.
51. Stakeholders are marked as ‘un-activated’ until they login for the first time and set up their contact profile along with a security PIN. Reports will show those stakeholders that have not yet activated their accounts and the ERMS system will then allow communication to those stakeholders requesting they activate their account.
52. The Usage Analysis report shows every stakeholder and their site, team and group memberships. The benefit of this report is to identify those stakeholders that may be expected to do too much during a crisis.
53. The Stakeholder Security report allows the ERMS Administrators to view the security settings for the users in their organization. The report can be filtered by Role (All, Administrator or Agent), by Surname or by ID. The security privileges are broken out by site. The ERMS system also allows a PDF version of the report to be generated.
54. ERMS can be instructed to send one-time or recurring reminders to stakeholders. Reminders can be in the form of a request to update contact information or a customizable message by the organization.
55. ERMS allows for change to the default order of the various contact devices for the organization. This order will determine the device sequence in which the system will contact a stakeholder. There are three areas where device order can be set: Stakeholder Custom Order, Default Device Order and Override Options at the time a message is sent.
56. The ERMS system allows the ‘Email From’ address to be set; this is the email address that will appear on all emails sent by the system. An appropriate setting ensures stakeholders will recognize it as an ERMS notification and not spam.
57. The ERMS system allows Customized Messaging to be added for notifications that will be sent with every notification delivered.
58. The ERMS system allows Customized Messaging to be turned on and off. The indicator determines whether a customized message should be included with all emails originating from the system.
59. The ERMS system allows multiple delivery regions to be defined, with each delivery region representing one or multiple inbound phone numbers.
60. The ERMS Auto-Protect feature gives the ability to set options to prevent repeated failed login attempts on any one account. A notification can automatically be sent when an account is locked.
61. The ERMS Locked Accounts feature lists the accounts currently locked out of the systems as they have exceeded their maximum number of login attempts within the retry interval.
62. The ERMS PIN Options give the ability to set options related to ERMS passwords, such as expiry and password length.
63. The ERMS Security Management feature manages access security in two ways, one of which is Stakeholder Role. Individuals are categorized when they are added to the Stakeholder database. This categorization provides specific generic authority. The three Stakeholder Roles are: Stakeholder—only receives and confirms messages, checks site status messages. Agent—may login to the web interface and perform any specific function they have been authorized for by the ERMS Administrator via Site Security. Administrator—has unrestricted access privileges for all functionality and all sites within the Operational Mask.
64. The ERMS Security Management feature manages access security in two ways, one of which is. Site Security. An ERMS Administrator defines what privileges an Agent has on a site-by-site basis. Security is inherited from main sites to the subordinate sites for each user specified as an Agent.
65. The ERMS system allows an organization to securely import stakeholders from internal systems or lists.
66. The ERMS system allows an organization to securely export stakeholder profiles to internal or external systems or lists.
67. The ERMS Stakeholder Search and Analysis feature provides the ability to search and filter stakeholder profiles based on available fields in the database.
68. The ERMS system allows information specific to a site to be available to individuals. Such information includes, but is not limited to, hazardous materials, number of employees and function or reach of the site.
69. The administrator functions of ERMS allow an organization to apply its policies, standards and naming conventions to the ERMS system, including but not limited to, length of password, templated status reports and alert level names.
70. Software processes in support of personal crisis response ensures an organization can effectively utilize system retained information to support the in-crisis requirements of executives and other key stakeholders, including; executive personal profiles, family member profiles, security escort profiles, personal identification data (e.g., photographs, scars, fingerprints, voiceprints, dental records, retina scans), domicile layout and security profiles, travel itineraries, common travel routes and vehicle identification.
71. Interrelationships between an organization's Crisis Management process (functionality within the software) and those provided by diverse Business Continuity Management (BCM) application systems are managed by the software in support of contact data verification, team assignment and resource distribution, BCP task status reporting and time to recovery determination.
72. Resident employees and other stakeholders of an impacted or threatened facility are readily identified through vital real-time links between the software and a facility's security and access control systems; providing the actual population of the site, the status of a stakeholder entry and regress, stakeholder physical position location monitoring and the overall facility lockdown status.
73. Safety protocols and procedures for stakeholders within remote branches, retail outlets or small operational centers are supported through direct interfacing of the software to a site's CCTV through the software's video-link functionality, including: real-time panic-alarm response, video imaging dissemination and automatic emergency services contact.

### Features/Functionality of Invention

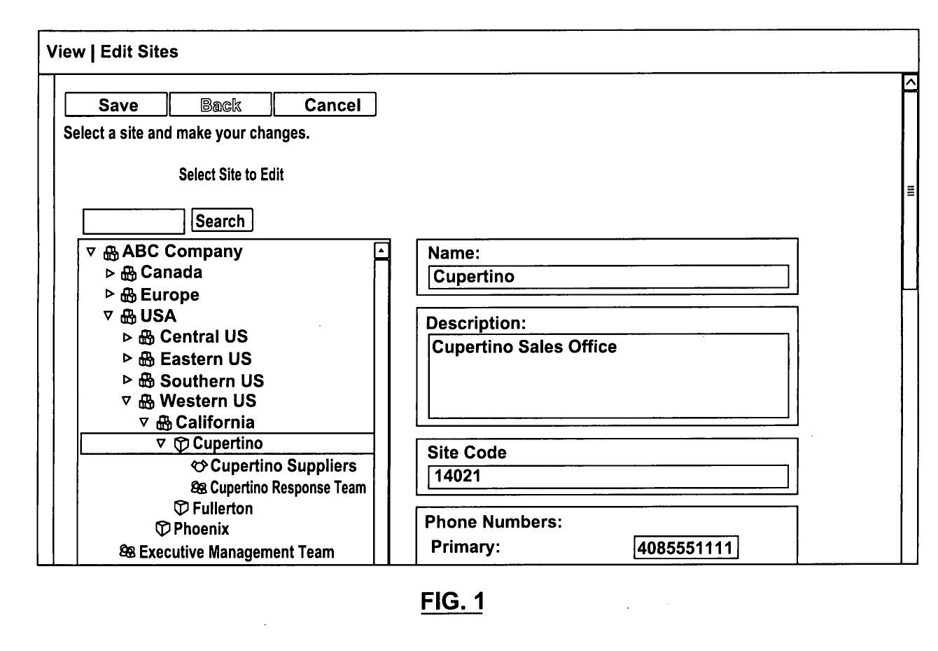

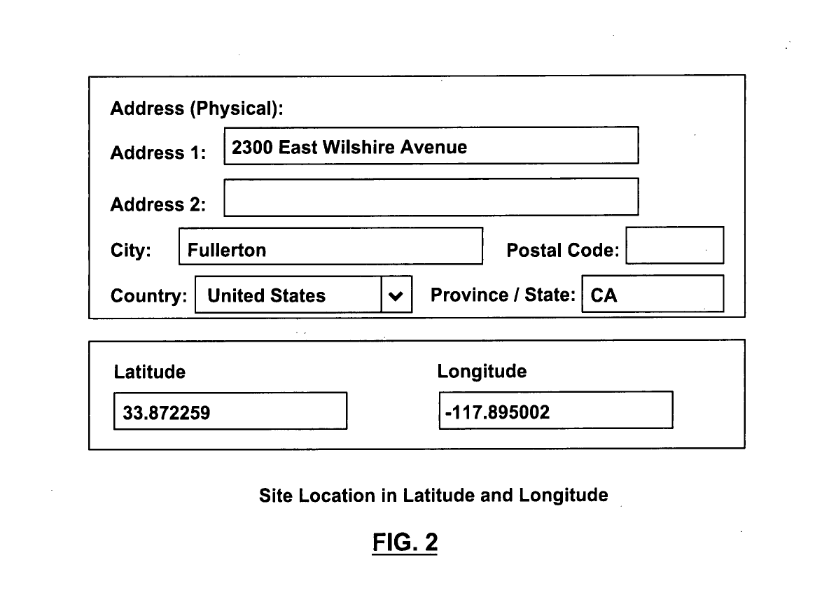

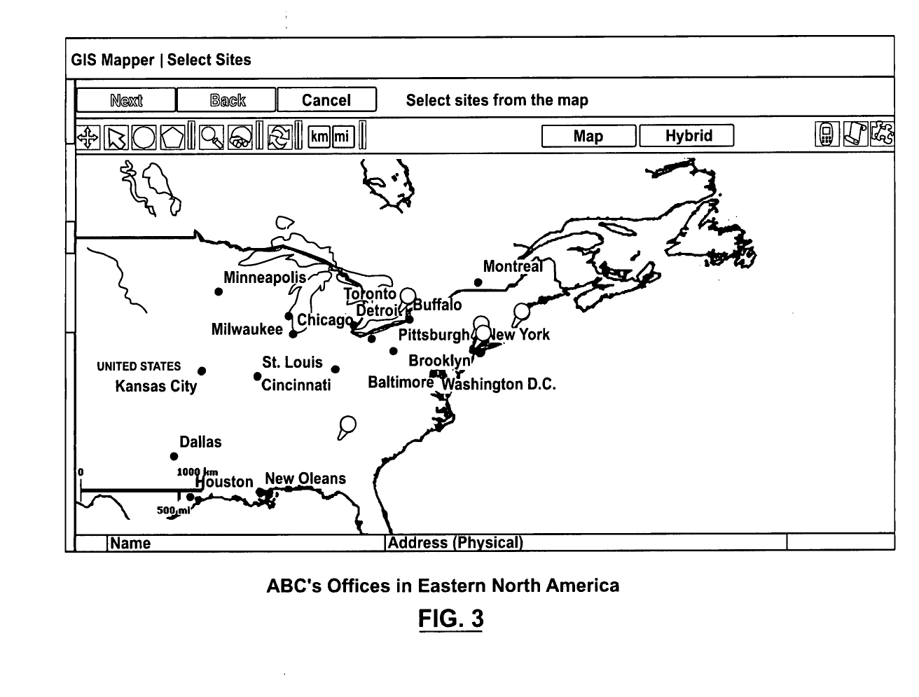

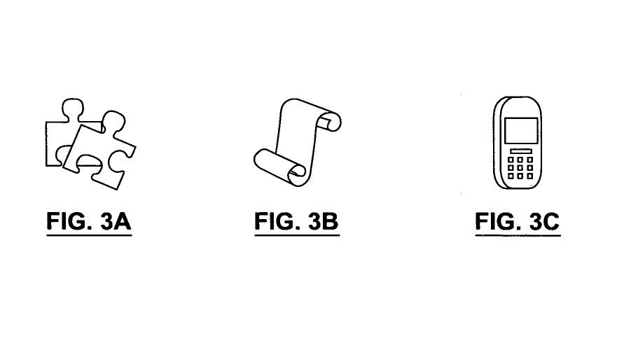

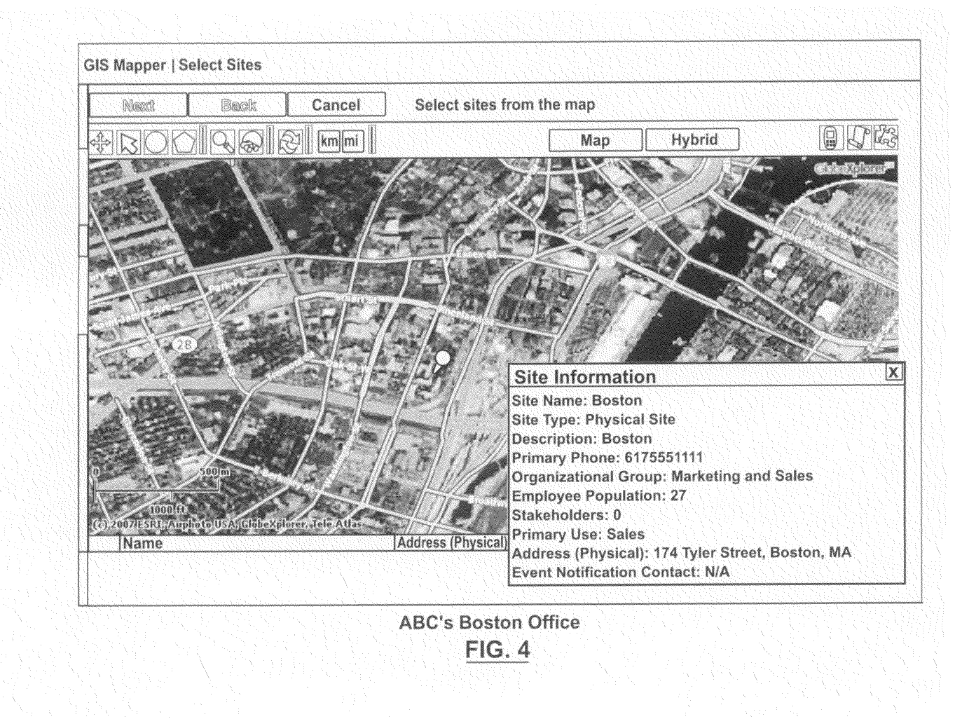

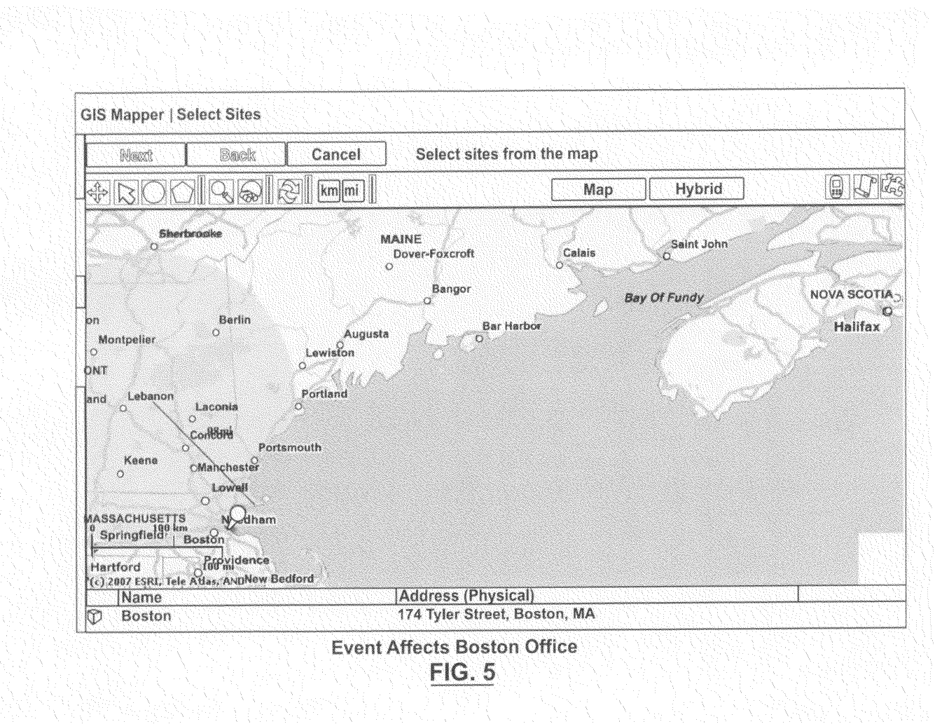

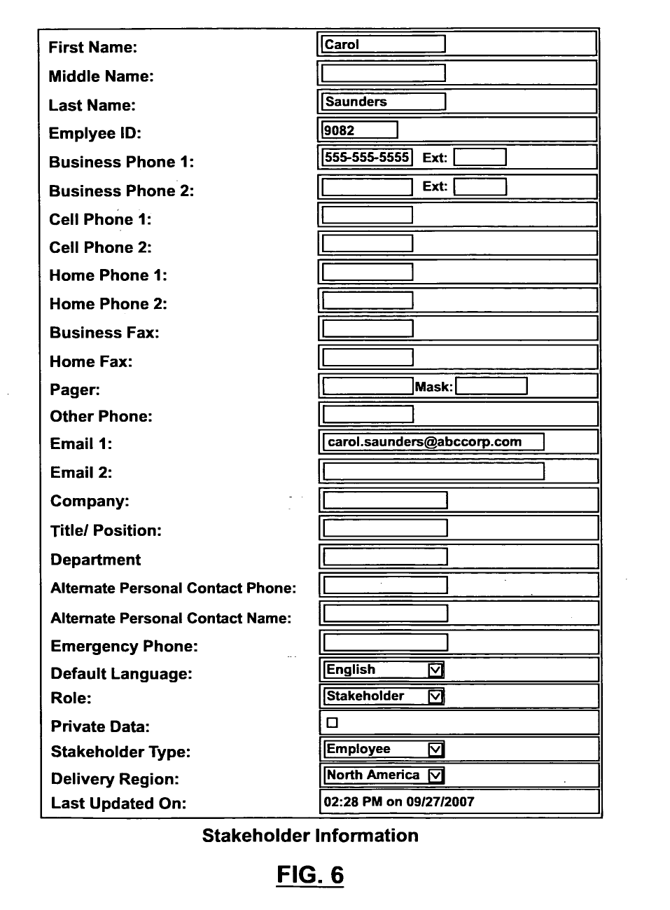

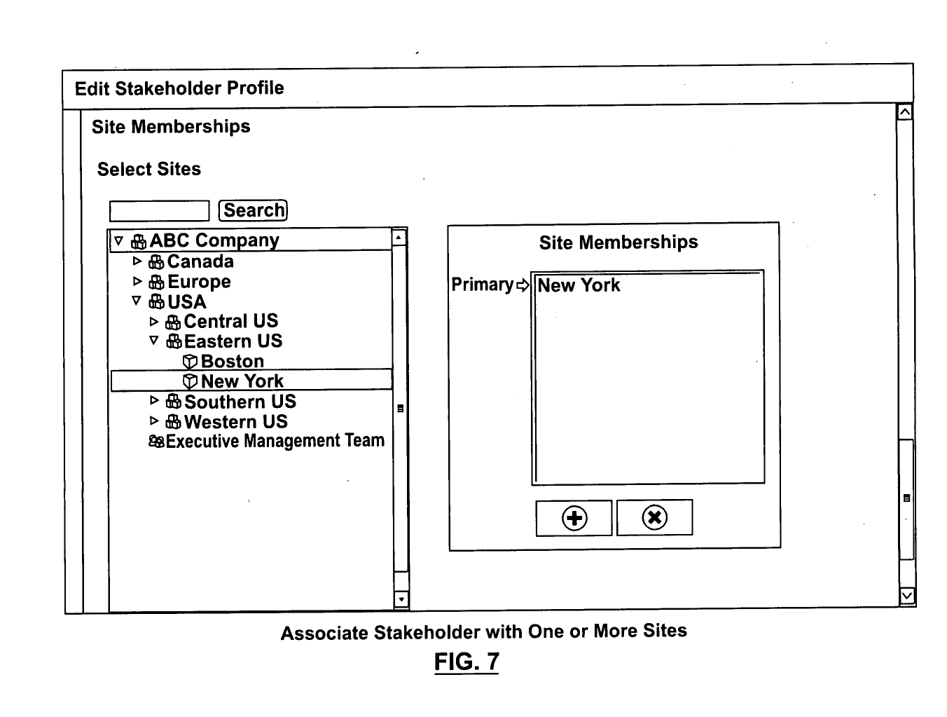

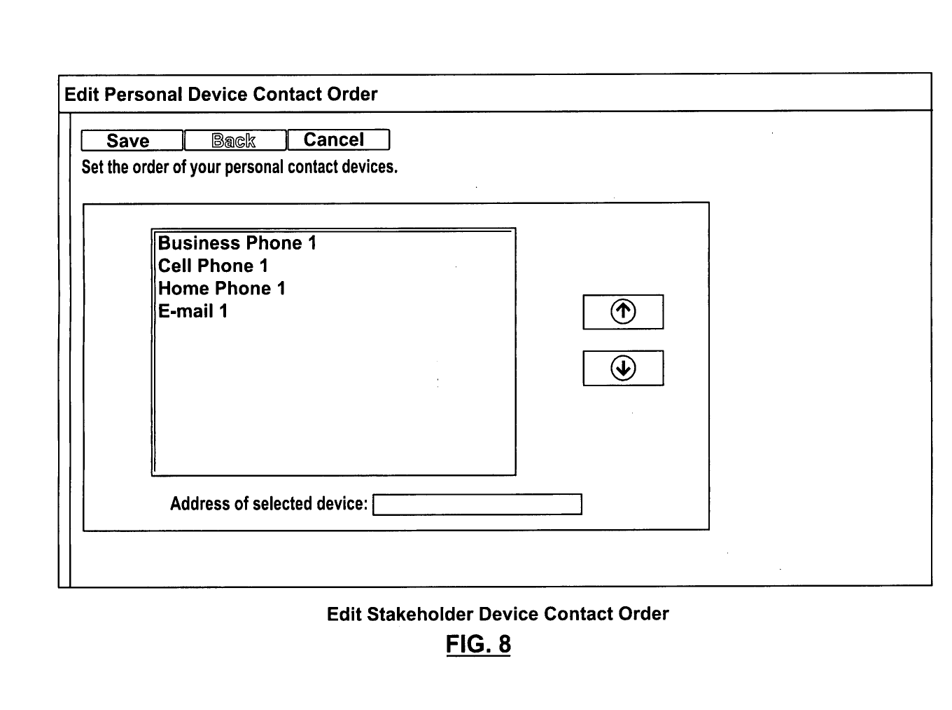

(1) Central to ERMS® is a hierarchical description of an organization's physical and logical sites showing the relationship they have with each other. An organization's physical sites may be described at any level of detail (e.g., buildings, floors, wings, office cubicle groupings). An organization's logical sites are not necessarily based on geography; they can be based on any common characteristics the organization chooses.
   Some examples of a logical site include:
      Sales Division
      Manufacturing
      Research Department
      Science Faculty Students
      Spanish-speaking New Hires
      Atlanta Distribution Center Customers
      Southern US
      Pacific Sales Region
      Eastern Seaboard
   All pertinent information for a site can be captured, including but not limited to, type of use and population. In the case of a physical site, address and longitude/latitude can also be captured. This database forms a unique Operational Mask for each organization.
   Sample Operational Mask
      ABC Company—Global HQ—247 West 18^{th} Street, New York, N.Y.
         Administration Department
         Human Resources Department
         Research & Development Department
         Manufacturing Department
         Sales Department
         New Hires
         Spanish Speakers
         Spanish-speaking New Hires
         USA
            Eastern US
            New York Sales Office—100 Lexington Avenue
            Boston Manufacturing—174 Tyler Street
            Central US
            Chicago Sales Office—250 N Wabash Avenue
            Southern US
            Atlanta Sales Office—6335 Spinnaker Lane, Alpharetta
            Western US
            Phoenix Manufacturing—2341 West Adams Street
            California
            Cupertino R & D Office—7352 Prospect Road
            Fullerton Sales Office—2300 East Wilshire Avenue
         Canada
            Eastern Canada
            Toronto R & D Office—2305 Eglinton Avenue West
            Western Canada
            Calgary Sales Office—3900 5^{th} Street SW
            Vancouver Sales Office—475 West Pender Street
         Europe
            UK
            London Sales Office—89 Charlwood Street
            France
            Paris Sales Office—81, Boulevard St Marcel
   FIG. 1 illustrates one way in which individual sites within the Operational Mask can be viewed. The information for the Cupertino office has been selected for display.
(2) ERMS® utilizes a GIS (Geographic Information System) to help an organization pinpoint the sites and their associated teams and individuals affected by a crisis. The Operational Mask can be viewed via a geographic map interface in addition to the tabular and hierarchical methods described in feature (1). When a system-recognized physical address is entered into the Operational Mask database, ERMS® immediately provides latitude and longitude coordinates for that site. FIG. 2 shows the address of ABC Company's Fullerton address and the corresponding coordinates computed by ERMS®.
   FIG. 3 provides a view of ABC Company's eastern North America offices, including New York, Boston, Atlanta and Toronto.
   FIG. 4 provides a hybrid view of ABC's Boston office; the satellite view is overlaid with map data identifying the local streets.
   In the simplest application of this GIS technology, a circle or polygon may be drawn on the map to highlight the sites that are included within the area contained by that shape.
   Once the sites are selected on the map, the user can initiate various functions by pressing the appropriate buttons shown in the top right corner of the screen shots of FIG. 3 and FIG. 4.
   These buttons are shown in FIGS. 3A, 3B, and 3C.
   FIG. 5 illustrates how an event in a neighboring state affects the company's Boston site. A circle with a radius of 98 miles is drawn from the location of the event. This circle encompasses the Boston office and, as a result, this office is identified below the map as an affected site.
   In a more analytical application of GIS technology, ERMS® allows for the capture and analysis of GIS based indicators that may be harbingers of imminent crisis situations. This information is then automatically layered on top of our representation of an organization's logical and physical infrastructure in order to facilitate automatic notifications. The initiations of these notifications are defined via the ERMS® interface by the organization and may include, but are not limited to, proximity to projected hurricane paths, earthquake epicenters, forest fires, tornado warnings, civil unrest, flood plains, winter storms and areas impacted by heightened homeland security alert levels.
   ERMS® supports the analysis of GIS based information in the context of emergency management. It allows a user to view and manipulate data as it relates to their logical and physical infrastructure. This data allows for more informed decisions to be made during the execution of a crisis response. Integration with our backbone of contact information allows for quick response by way of mass communication to stakeholders who may be impacted by the situation. Data may include current and forecasted weather, traffic conditions, airport delays, population density and proximity to emergency services.
(3) For each site within the Operational Mask, a unique profile can be created. This profile provides detailed physical and operational information about a location, including but not limited to, purpose/use, age, safety analysis, fire detection/suppression analysis, hazmat location analysis, proximity analysis and neighbor analysis. There is also access to the document repository, discussed in feature (12), for site floor plans, layouts and emergency evacuation plans.
(4) The database provides a list of employees, vendors, suppliers and customers (generally called stakeholders) associated with sites and their respective descriptive information including department and contact information specifying multiple email and telecommunications devices. Each stakeholder is linked to one or more sites in the Operational Mask as appropriate.
   FIGS. 6, 7 and 8 illustrate the information that ERMS) associates with a stakeholder. FIG. 6 shows a stakeholder for which information is provided for two devices, namely Business Phone 1 and E-mail 1. FIG. 7 shows that a stakeholder has been associated with the New York office. FIG. 8 shows four devices for which information has been provided for a different stakeholder.
   If stakeholder information already exists in an organizational Human Resources database, this information can be automatically imported into the Operational Mask database. When information in the Operational Mask database is updated, the new and/or changed information can be automatically exported to the Human Resources database. ERMS® has interfaces to several contact provision systems and databases, including but not limited to, organizational Human Resources systems, email directories and real estate databases.
   As previously mentioned, the stakeholders can define their preferred order of communication devices when being contacted by the system. This preferred order can further be defined based on day of week and time of day. ERMS® supports diverse escalation routines. A stakeholder defines an escalation routine by specifying the order in which communication devices are cycled. For example, if a stakeholder defines the preferred communication device order as business phone, cell phone, home phone and email, the manner in which the stakeholder is contacted can be described in a number of ways. The following three escalation routines are examples:

| | | |
|---|---|---|
| Routine A | Routine B | Routine C |

| | | | | | | |
|---|---|---|---|---|---|---|
| Business Phone | 1 | 2 | 1 | 5 | 1 | 2 |
| Cell Phone | 3 | 4 | 2 | 6 | 1 | 2 |
| Home Phone | 5 | 6 | 3 | 7 | 1 | 2 |
| Email | 7 | | 4 | | 1 | 2 |

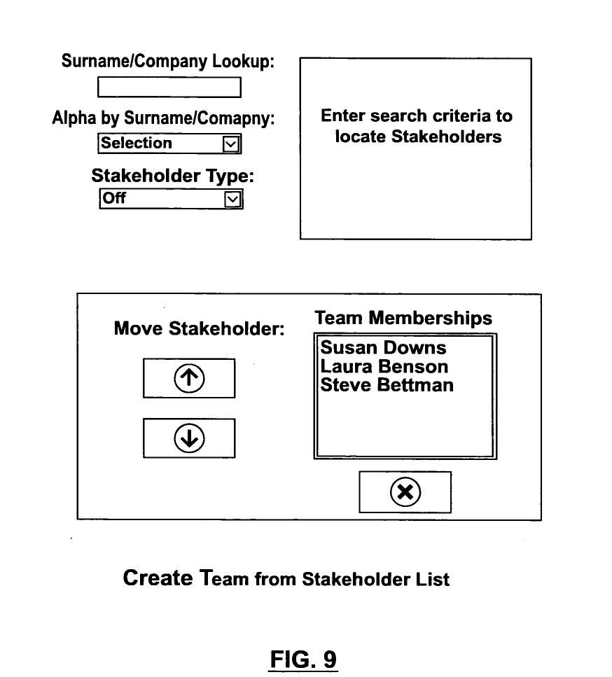

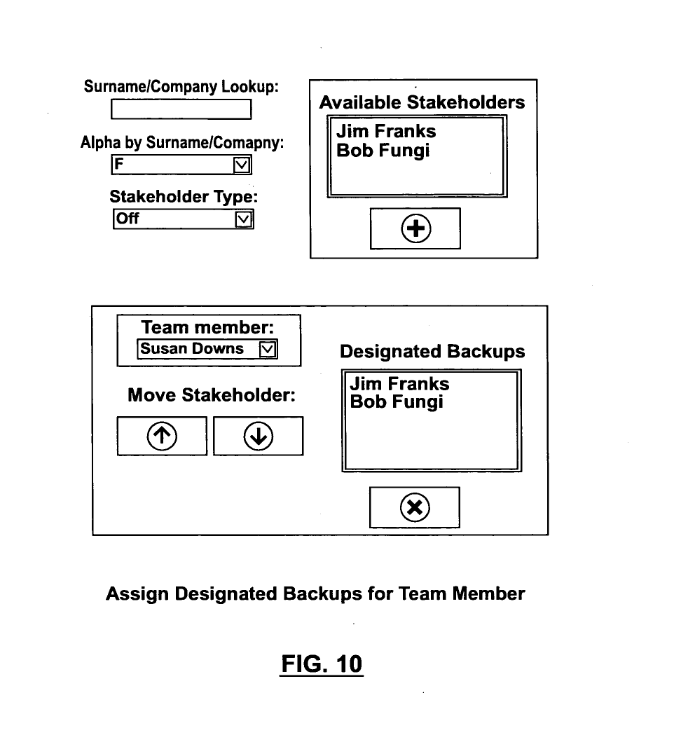

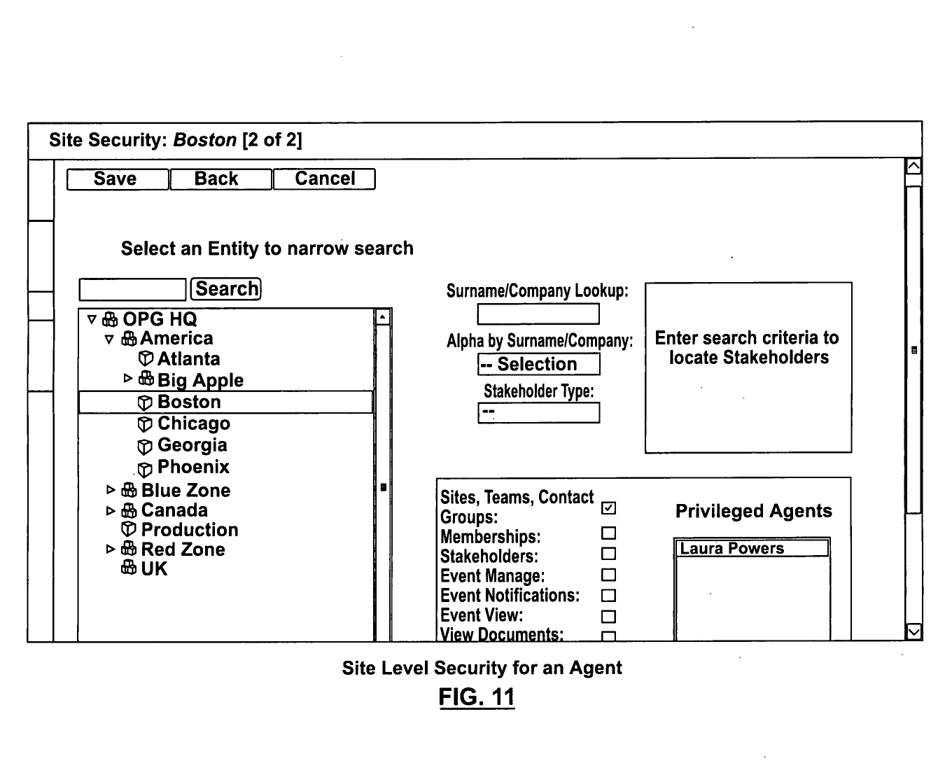

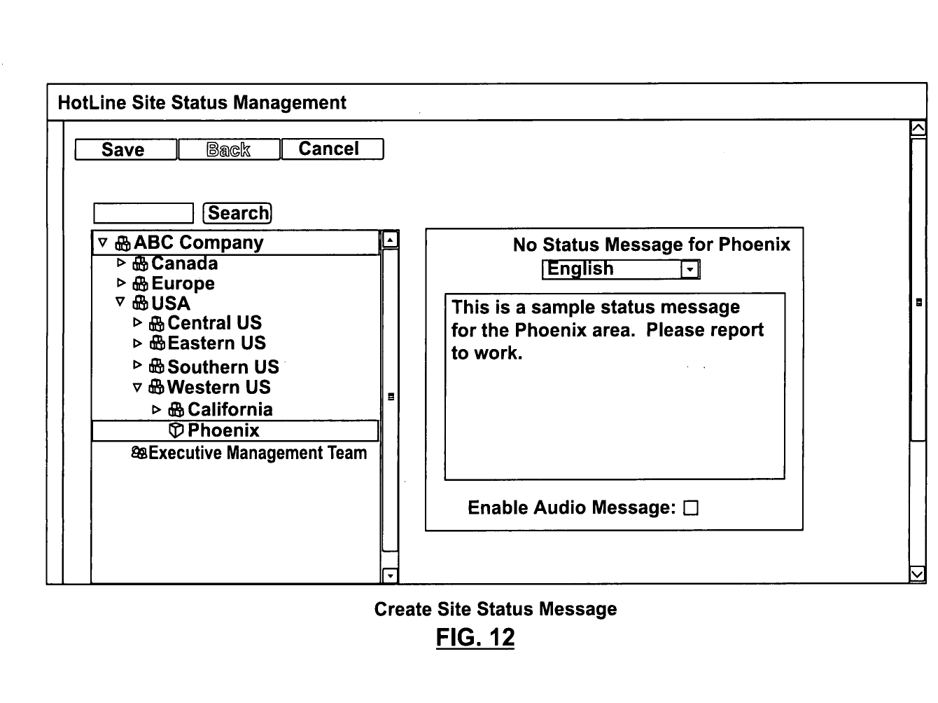

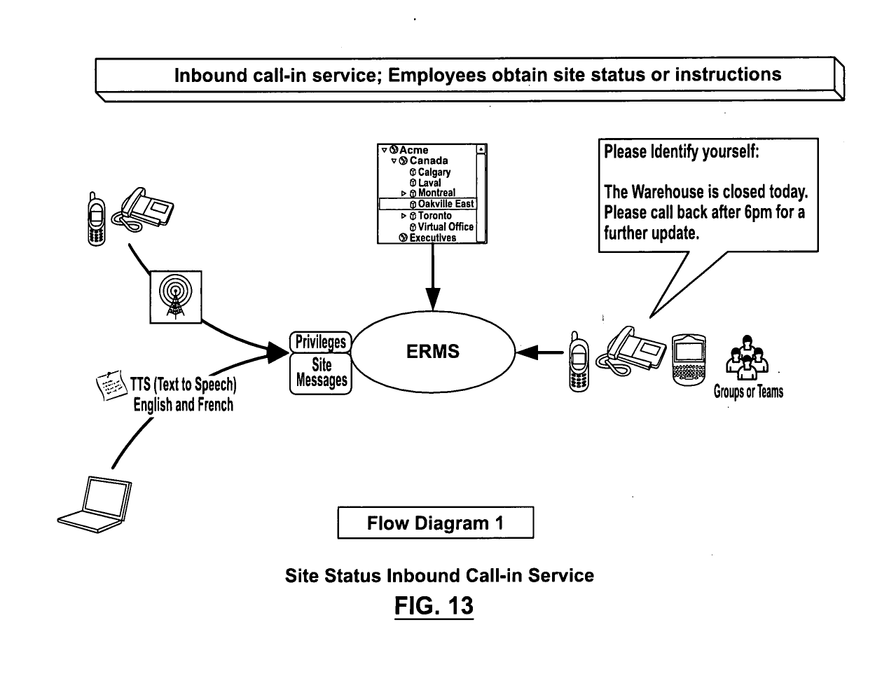

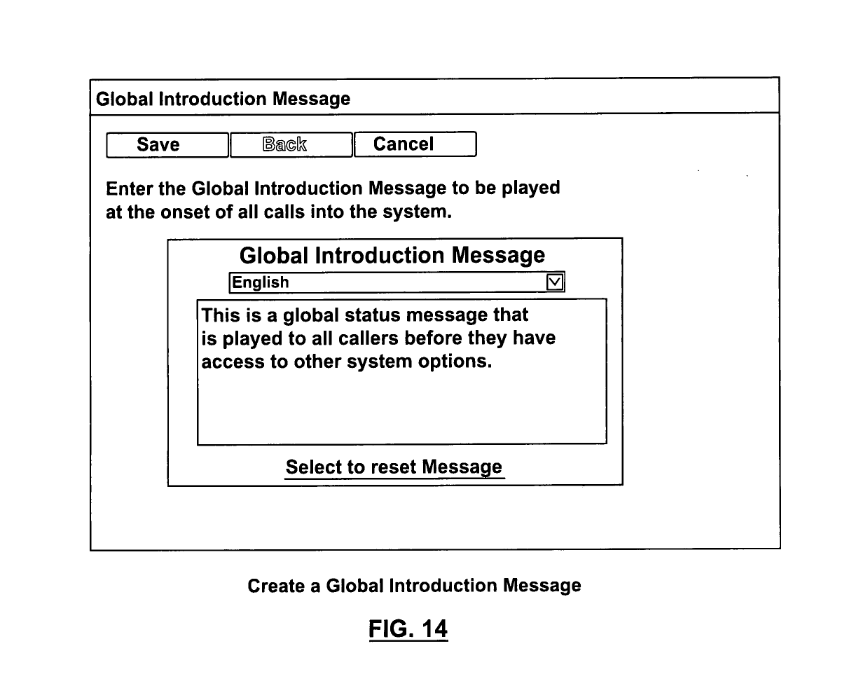

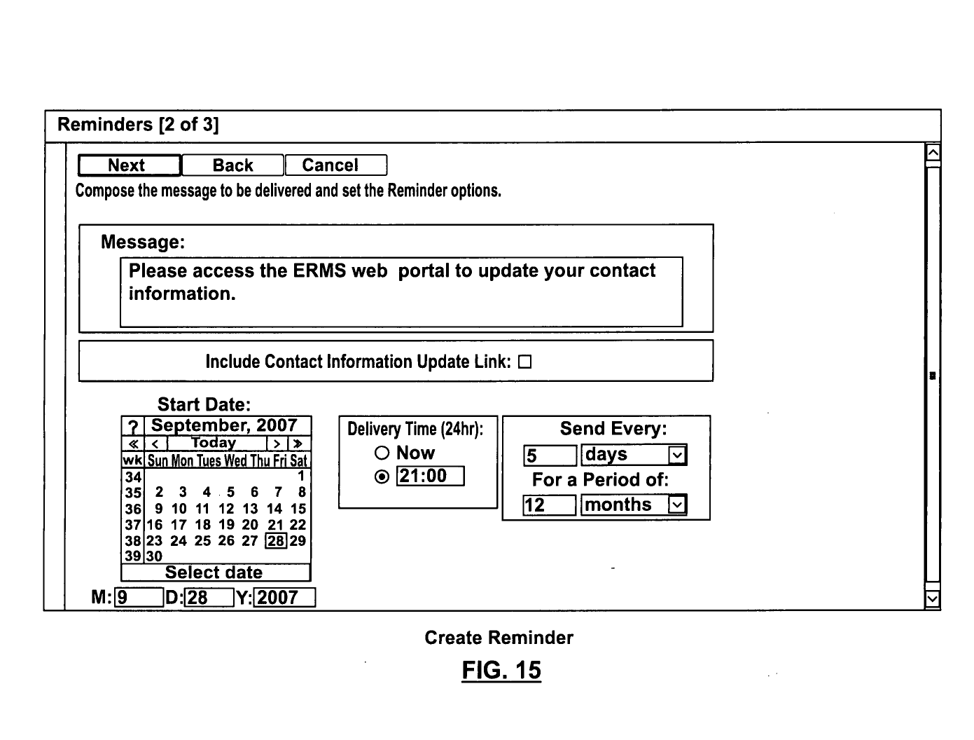

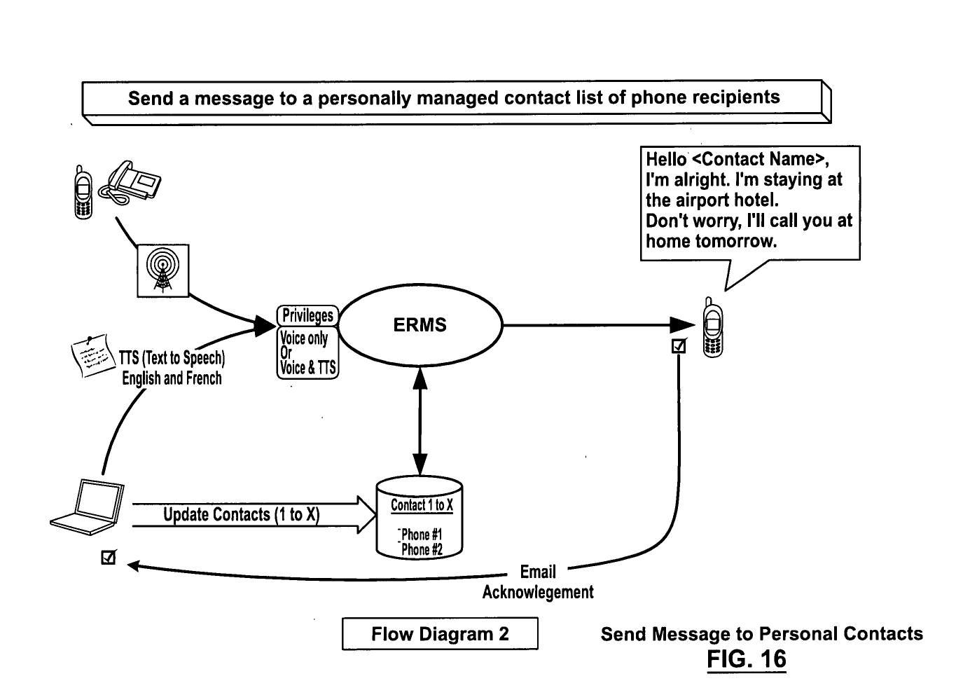

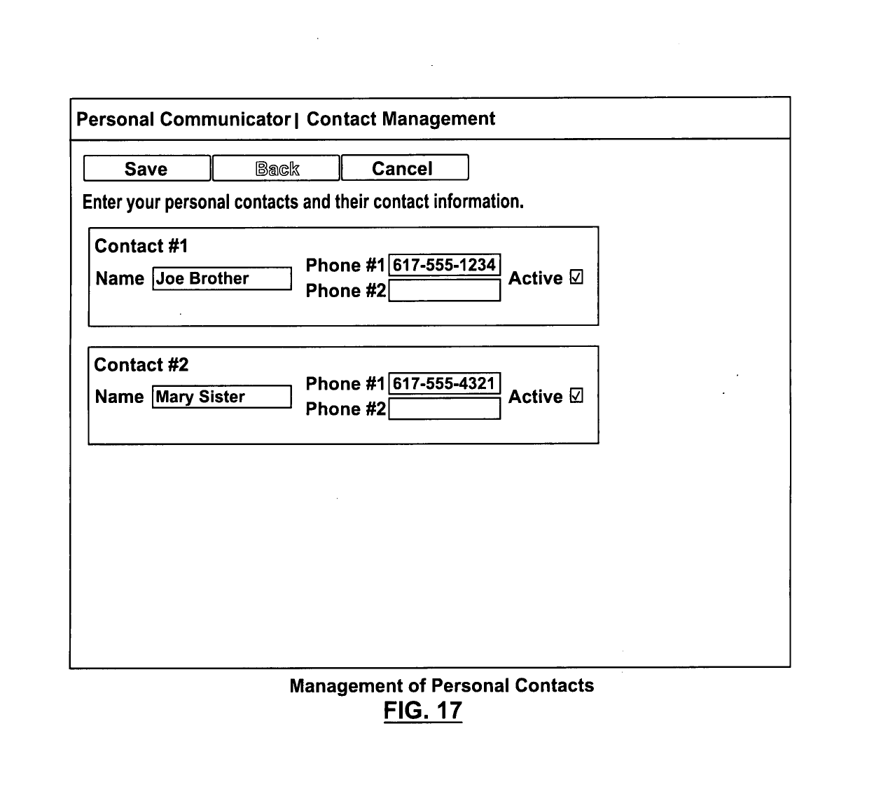

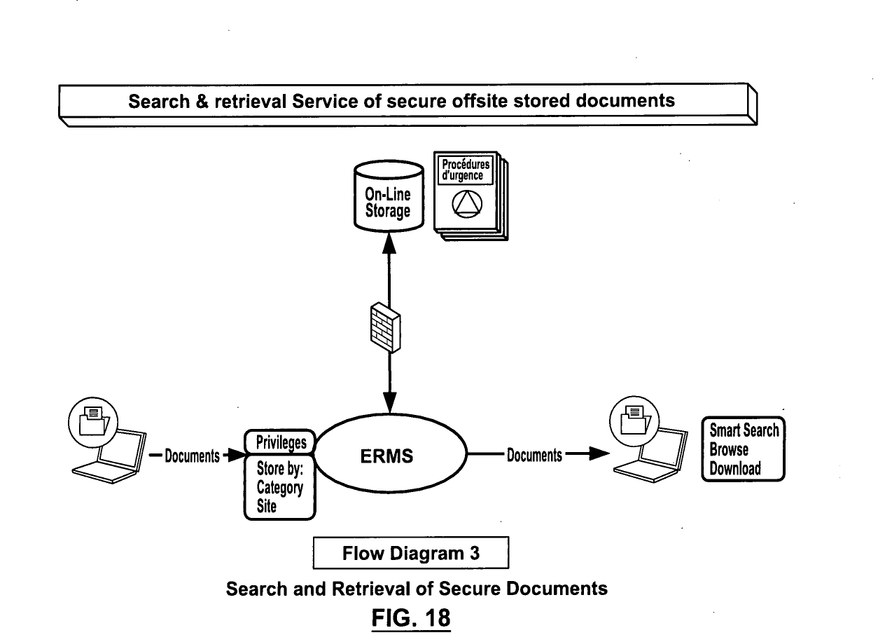

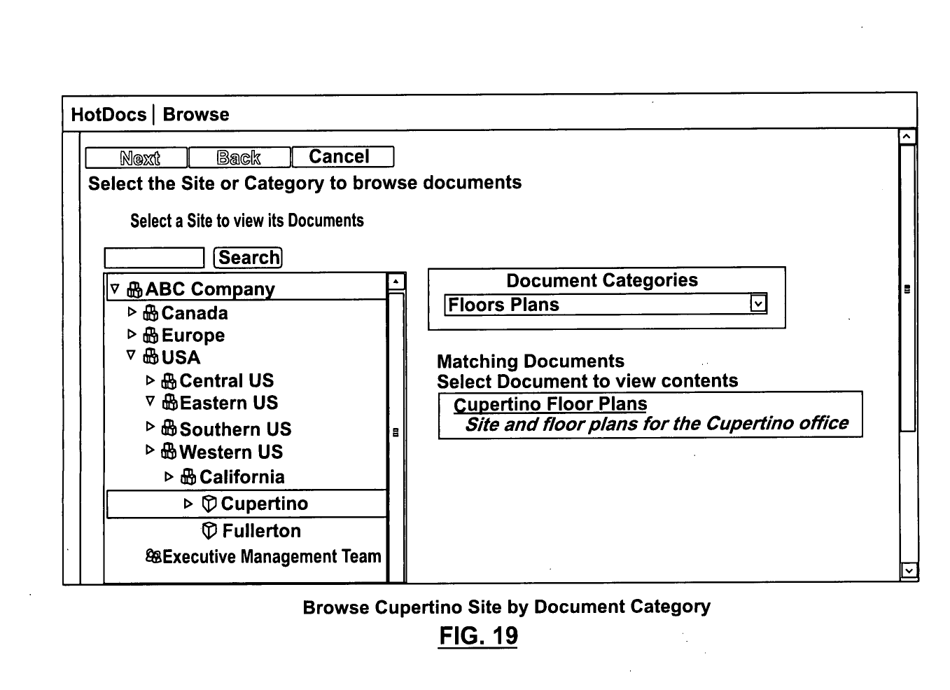

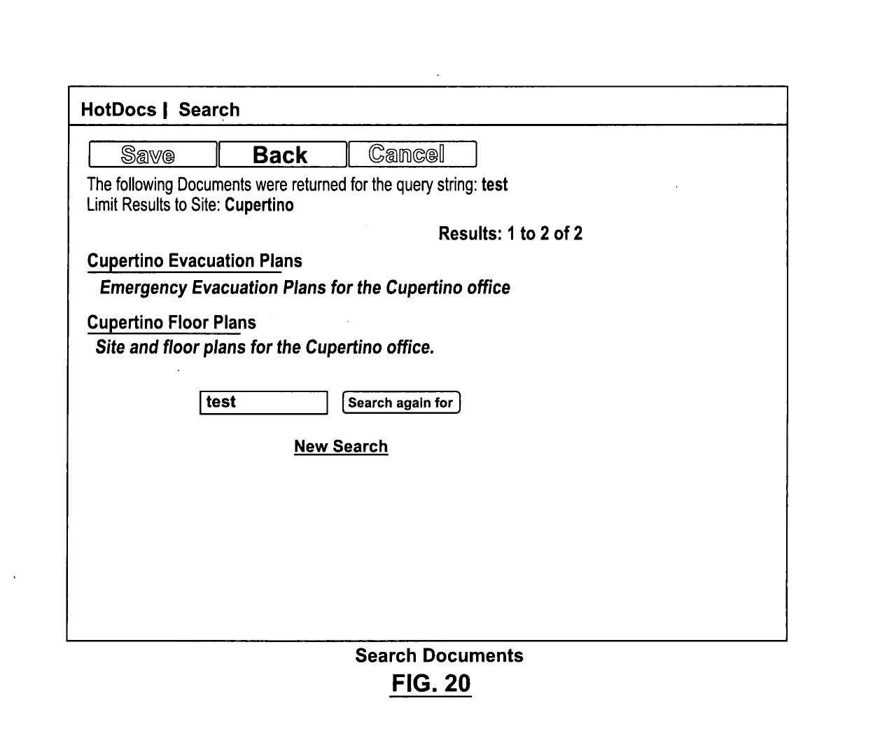

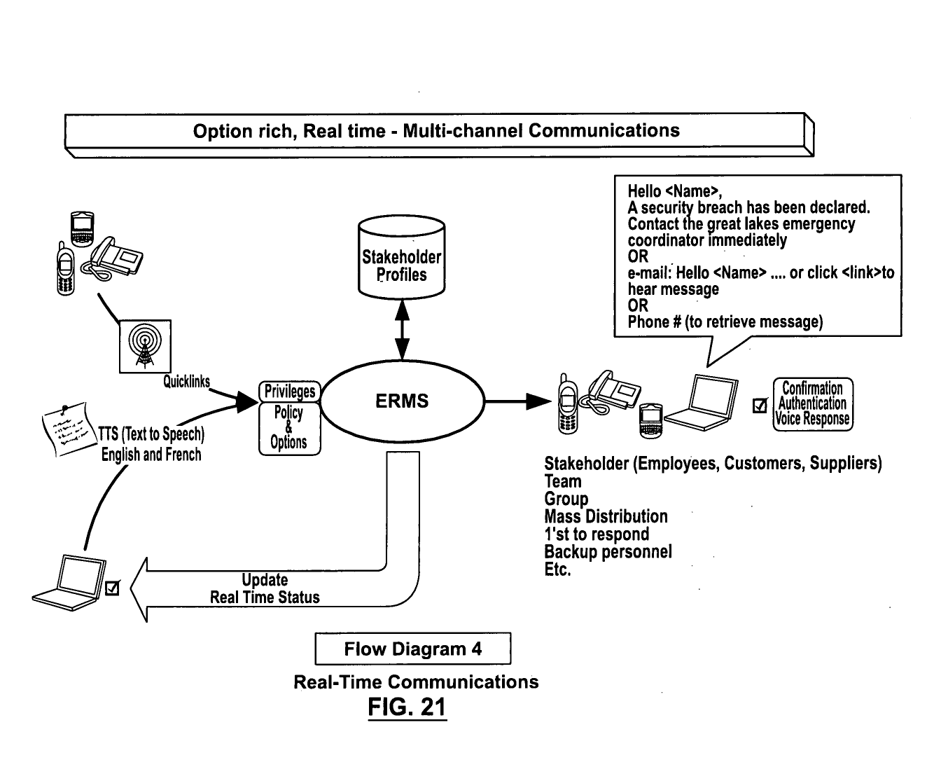

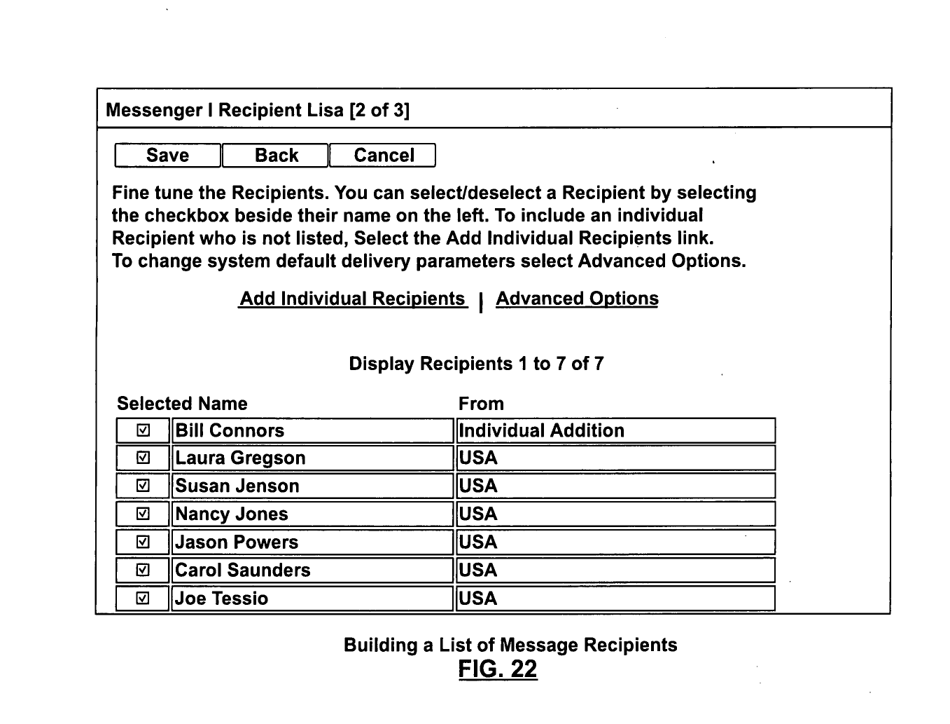

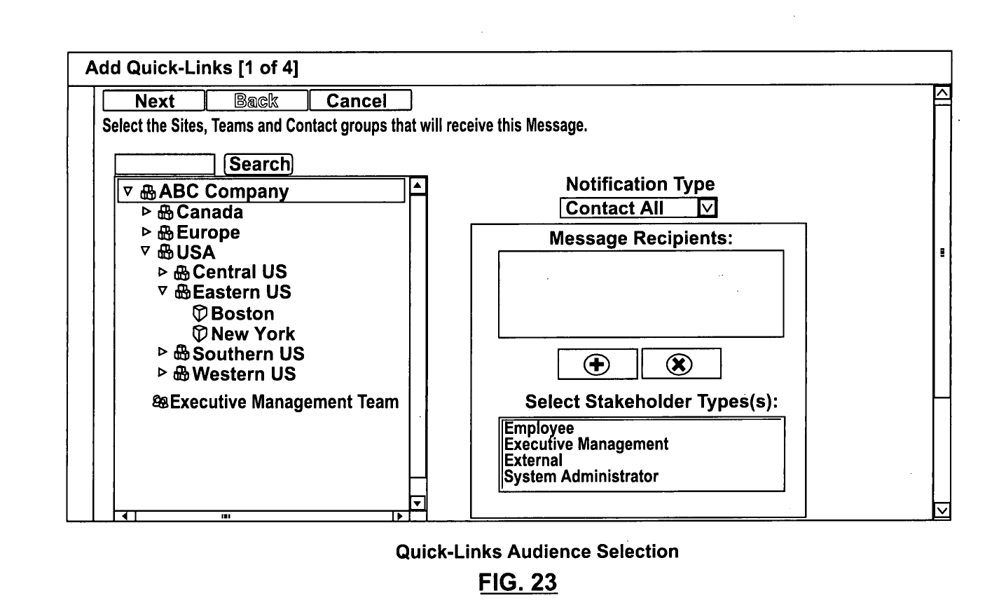

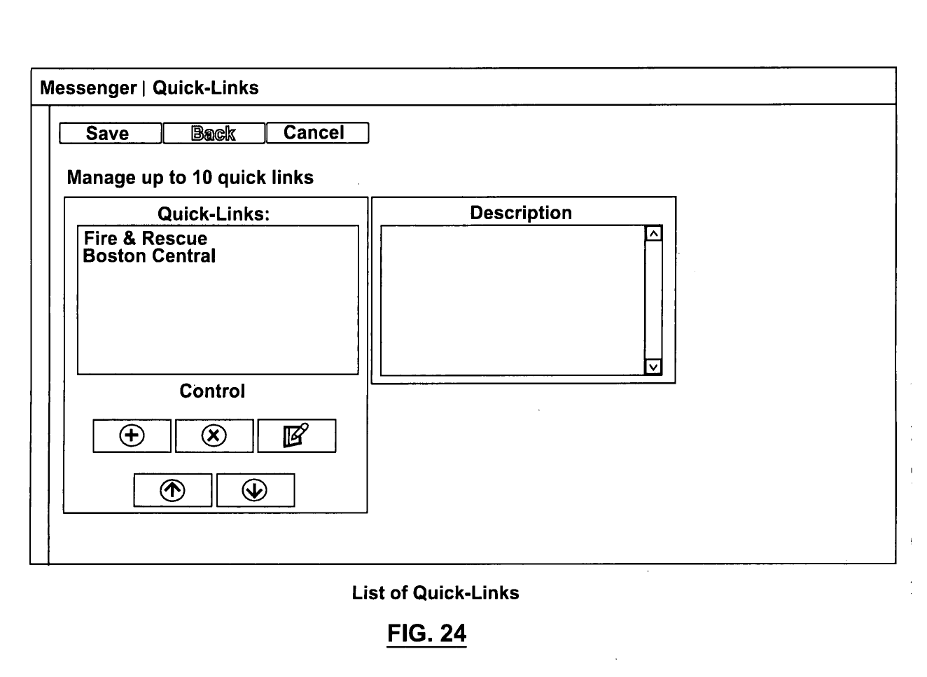

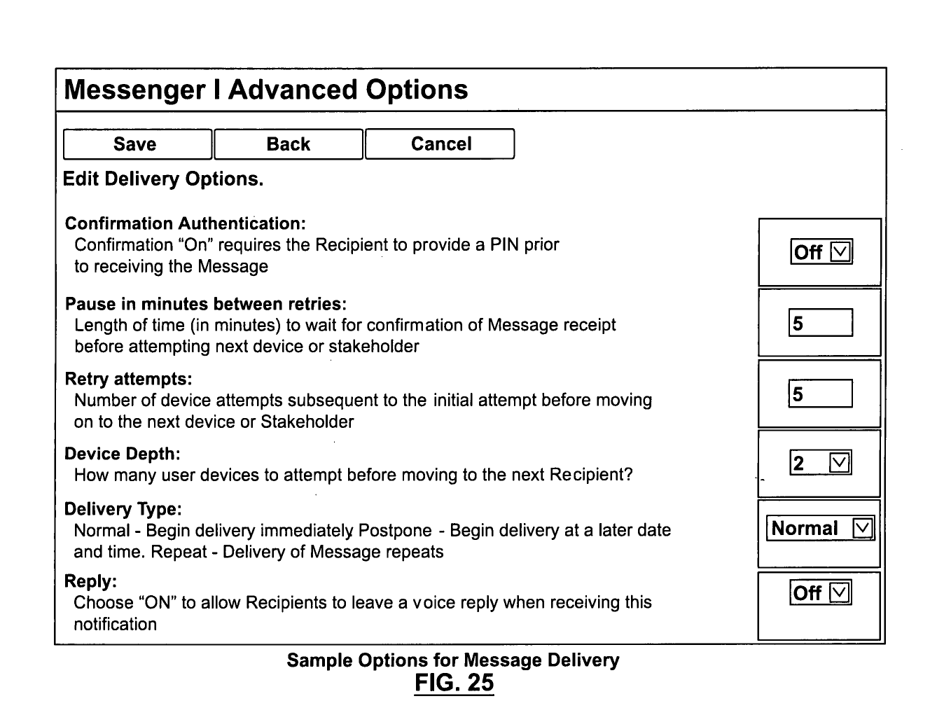

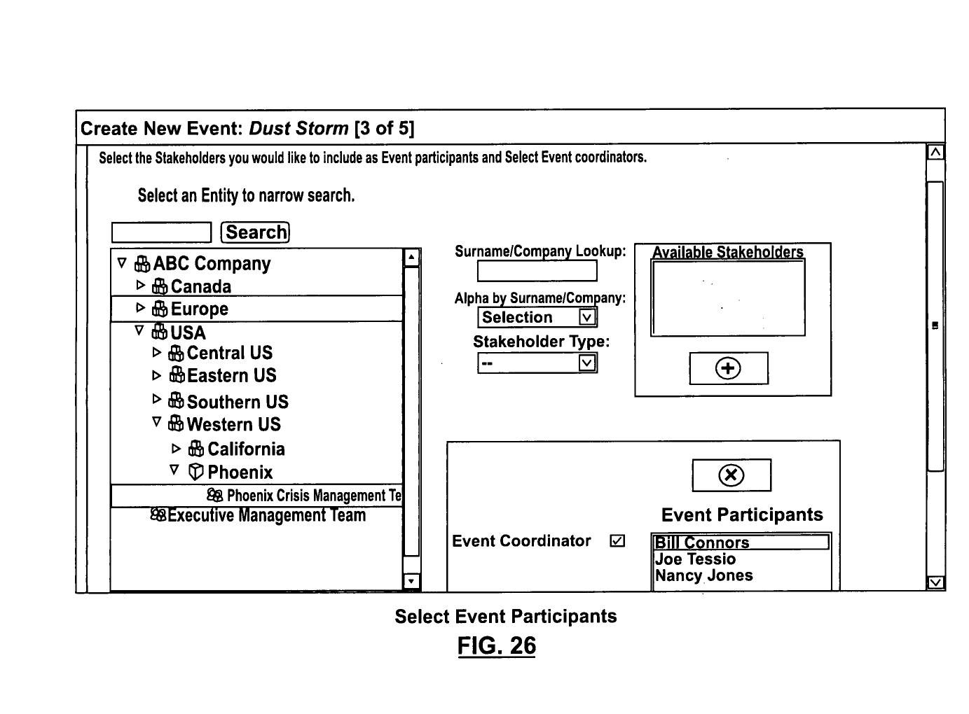

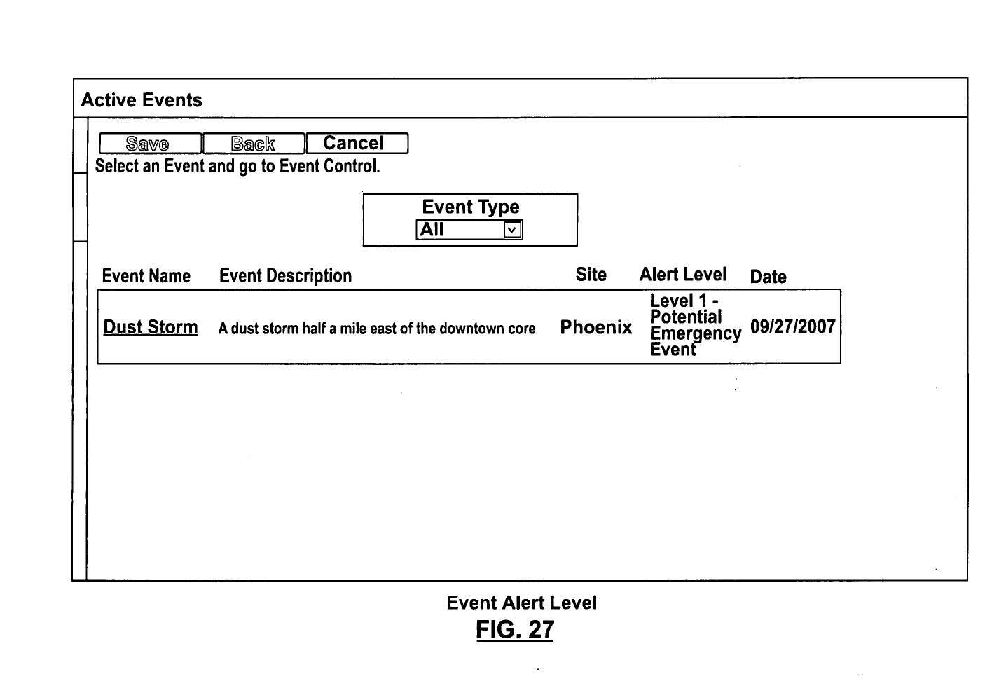

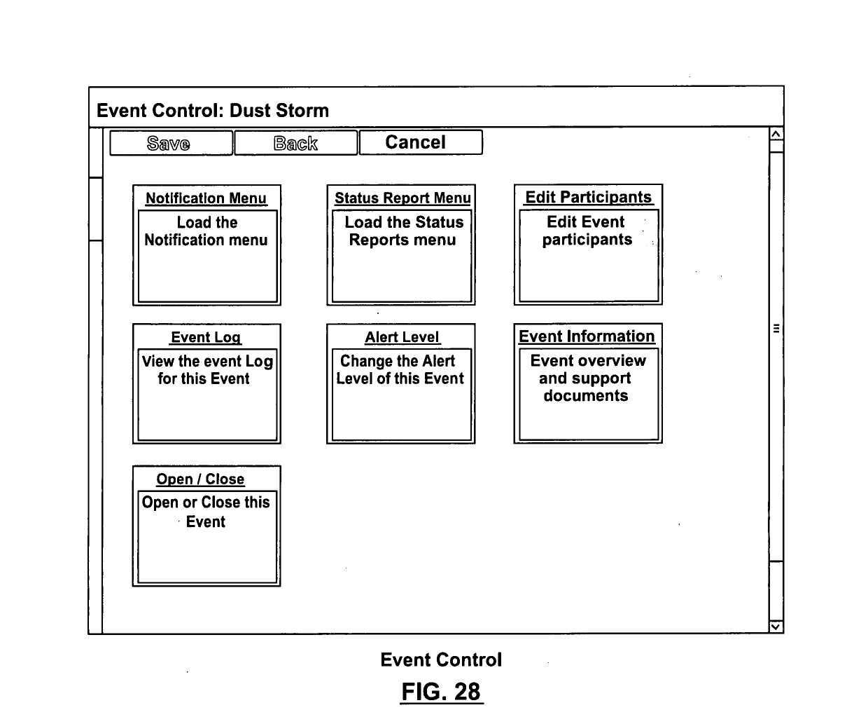

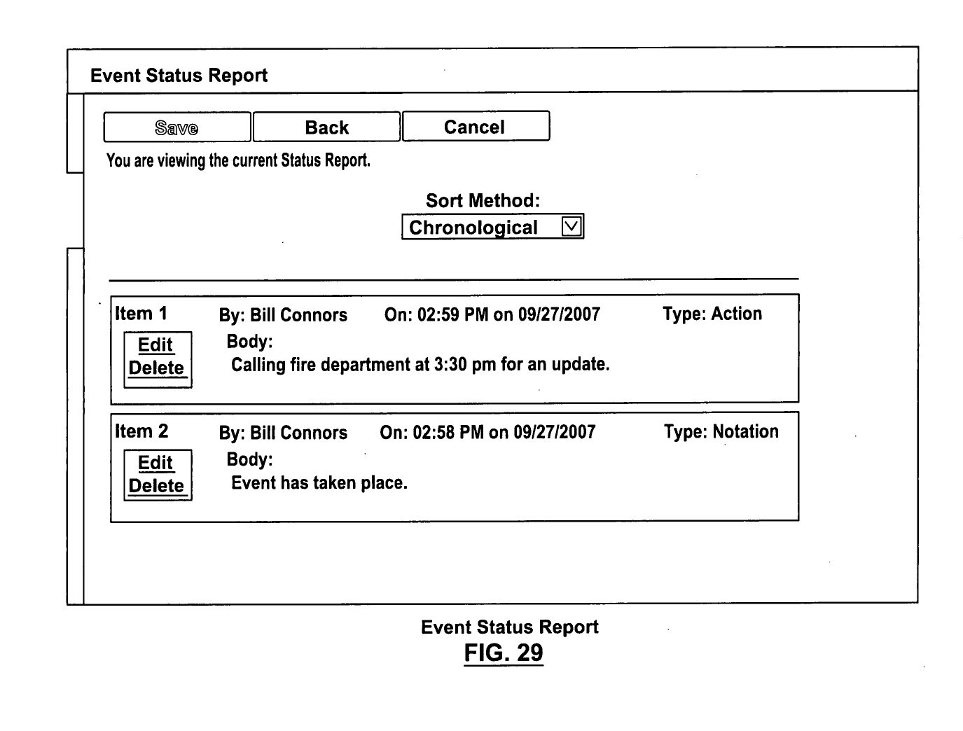

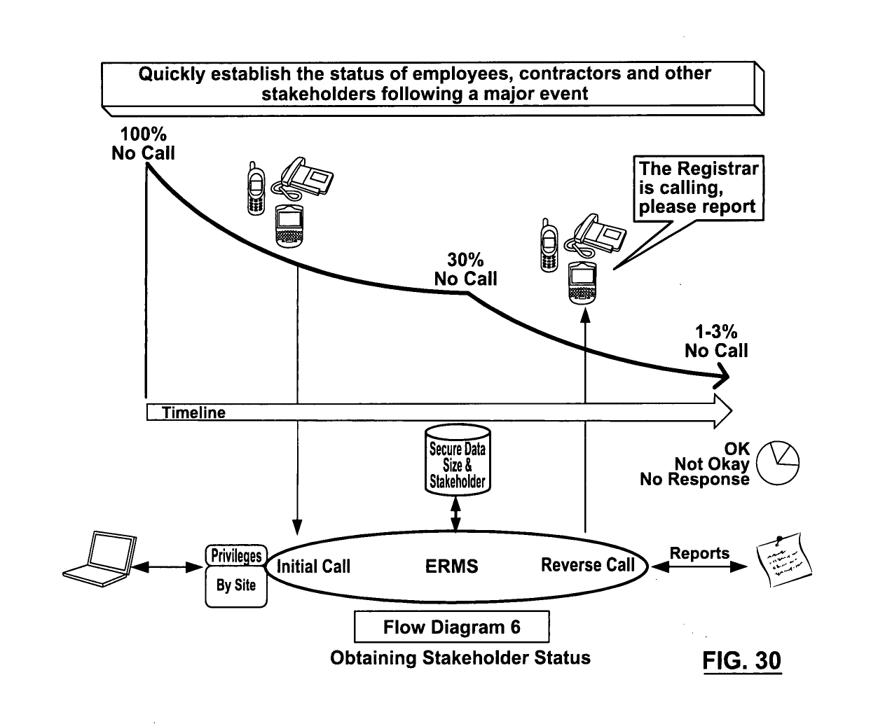

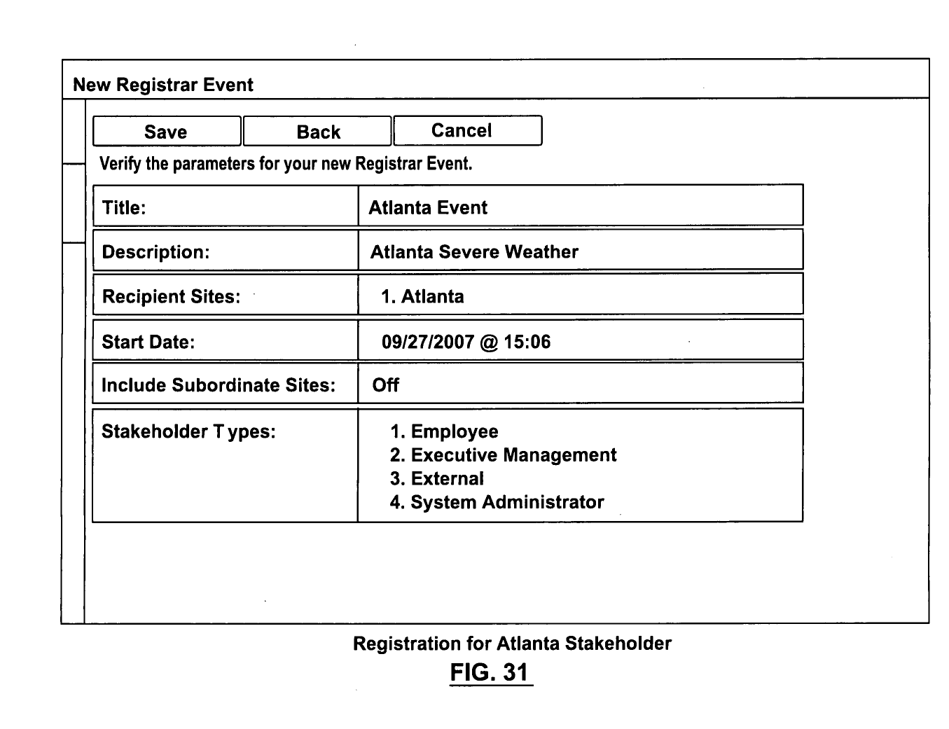

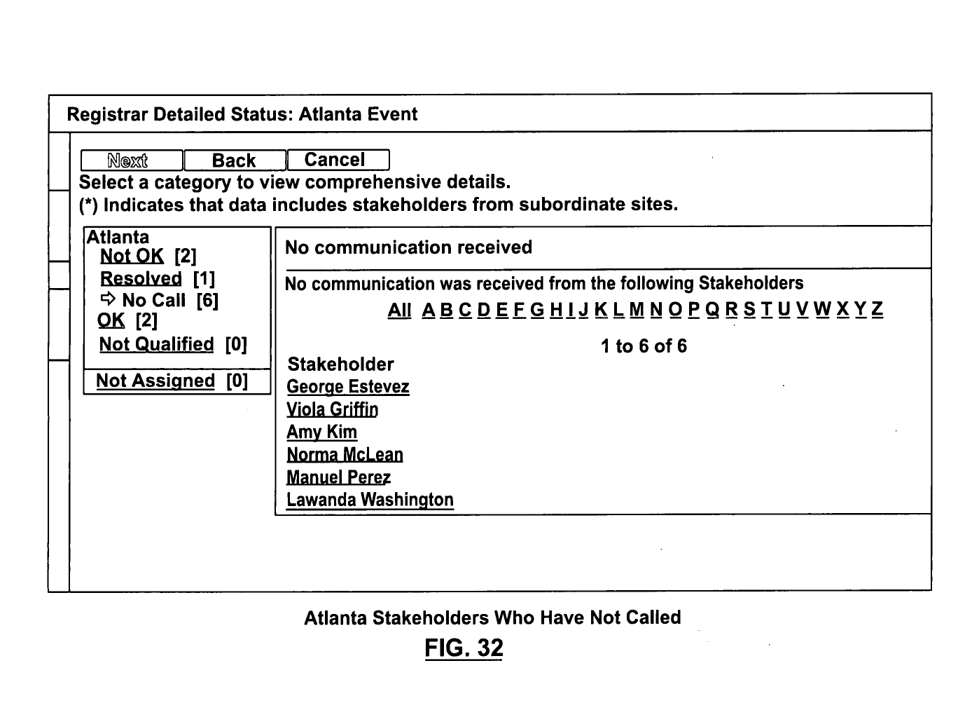

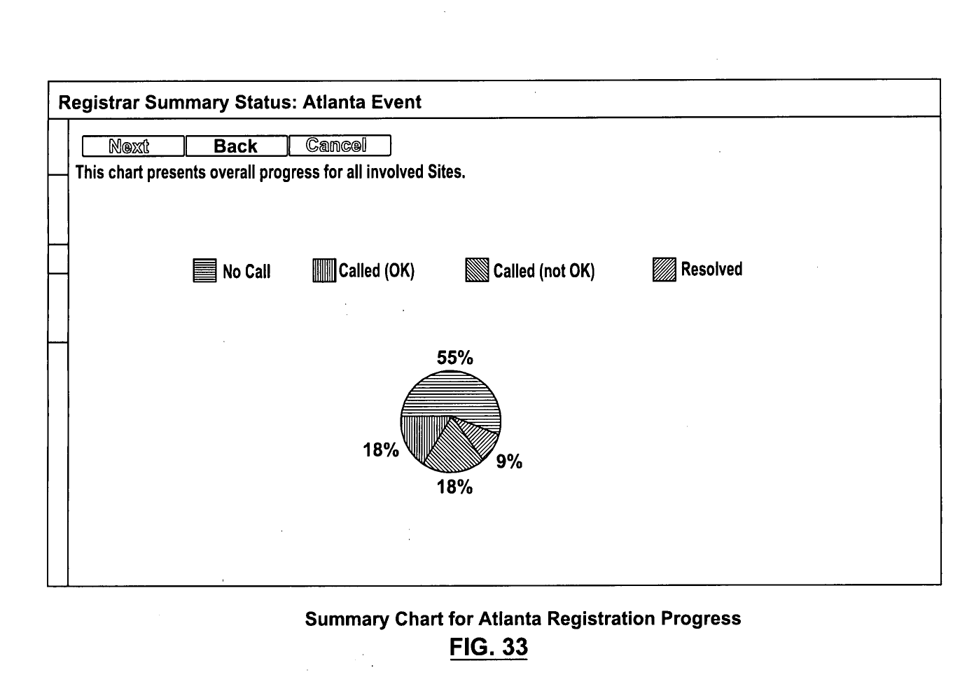

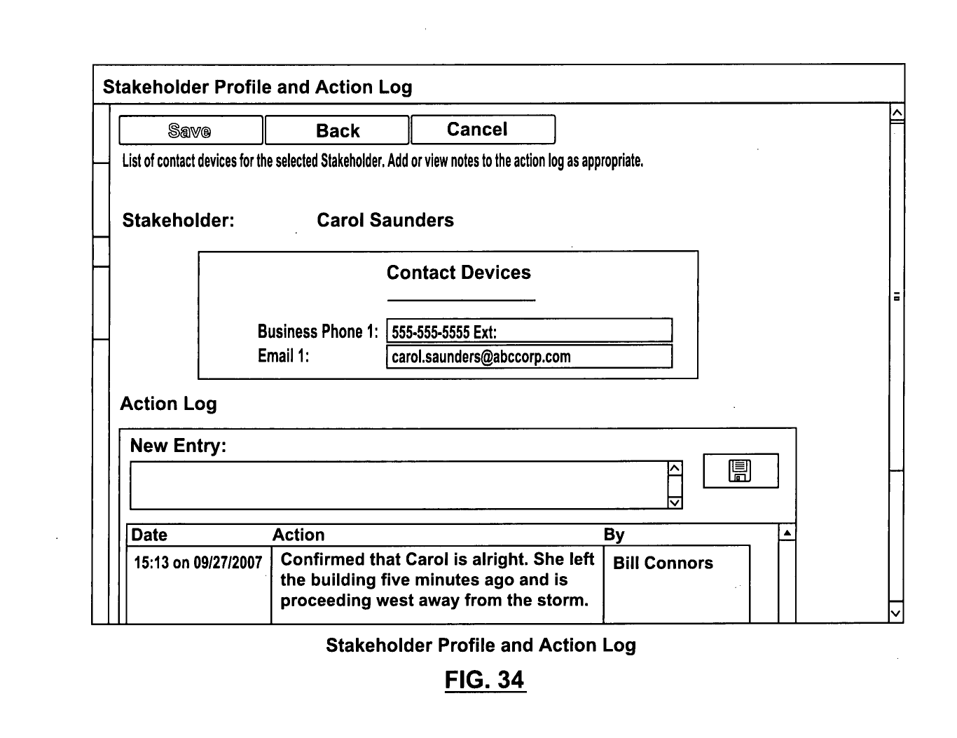

Routine A attempts to contact the stakeholder twice on the business phone before escalating to the cell phone. This pattern repeats until the seventh communication attempt which is via the email account of the stakeholder. Routine B, on the other hand, attempts to contact the stakeholder only once on the business phone before escalating to the cell phone. If the stakeholder does not respond after the fourth communication attempt, which is via the email account, then Routine B tries again to contact the stakeholder on the business phone. Routine C uses a broadcast approach by attempting to contact the stakeholder on all devices at the same time. If the stakeholder does not respond within the allotted time, Routine C repeats the broadcast to all four devices.
The three examples shown here illustrate the variation in which an escalation routine can be defined. An individual stakeholder may not be contacted at all if the type of campaign is set to “first to respond”. See feature (15) for a full description of the options available.
(5) The database provides further categories of teams and groups. Teams and groups are defined at any specific level in the Operational Mask. An unlimited number of teams and groups can be formed by naming the team/group and then linking one or more stakeholders to that team/group. Each member of the team/group is ordered (from 1 to n where n is the total number of members) to provide a structured context to the team/group. Each member of the team/group can have one or more stakeholders identified as designated backups. The designated backup list is also ordered in the same fashion as the team/group to provide context.
   ERMS® provides much flexibility in the manner in which members and designated backups are contacted. During a campaign to contact the members of a team or group, member 1 is contacted first. In the simplest configuration, if member 1 does not respond, designated backup 1 for member 1 is contacted next. This pattern continues until the last designated backup for member 1 is contacted, after which member 2 is contacted. In a different configuration, the designated backups may be contacted in random order. It is also possible to have member 2 contacted before the backups for member 1 are contacted.
   FIGS. 9 and 10 illustrate how a team/group is created and designated backups are assigned. FIG. 9 shows a team of three stakeholders. FIG. 10 shows two designated backups for one of the team members.
(6) Individuals within an organization can be given authority to perform specific functions within ERMS at one or more specific sites. FIG. 11 illustrates how this is done. An employee named Laura Powers has been given authority at the Boston site to create and manage sites, teams and contact groups. Authority is granted at subordinate sites as well, although in this example, Boston has no subordinate sites. Any individual granted authority in this way is known as an ERMS Agent. Examples of where Agents would be assigned include:
   Public Affairs and Communications would assign ERMS Agents with the authority to create and disseminate communications. Different ERMS Agents can be established for internal versus external communications.
   Information Technologies would assign ERMS Agents with the authority to distribute information/instructions on the detection and eradication of a computer virus.
   The organization's Crisis Management Team members would be established as ERMS Agents with the authority to activate the Crisis Management Plan and create/maintain a corresponding Event Record.
   ERMS Agents would be established for the coordination of all critical documents entered into the ERMS document repository.
   There are no restrictions on the number of ERMS Agents that can be established. Consideration only needs to be given to what makes sense. An organization establishes ERMS Agents to restrict the number of stakeholders who can perform certain functions or to create a structure that can be better managed in a crisis through a distribution of tasks.
   The individuals who determine which stakeholders will be ERMS Agents are known as ERMS Administrators. These individuals are typically very few within an organization and are responsible for the data integrity, data synchronization, security and overall utilization planning and control of ERMS.
(7) The system provides two methods (web and phone) of updating status information regarding each site within the Operational Mask. An ERMS Administrator (or ERMS Agent with the appropriate authority) can enter a text status message for each location via a web interface. This status message is stored in the database and linked to the site in the Operational Mask. The system administrator can also add a recorded voice message to each site by calling into a special phone number to access the system and record the message. As soon as this status information is entered, it is available immediately to the stakeholders via web or phone.
   FIG. 12 illustrates how a system administrator for ABC Company creates a site status text message for the Phoenix office.
(8) Stakeholders and employees can call into a phone number (typically toll-free) to access the real-time status information for their site. Each organization has one or more dedicated phone numbers. When a stakeholder calls in, the system checks their Caller ID to determine if this is a “known” person in the database of sites and contacts. If there is a match, the system knows the site location where that person normally works. If there is no Caller ID match, the system prompts the user for identification via Employee ID, home phone number or work phone number. If requested by the caller via a menu offered by the system, the system plays back the recorded voice message for that site if a voice message exists. If no voice message exists, the text status message is played back using Text To Speech (TTS) voice technology. If no text status message exists for that site, the system plays back a default message established by the system administrator such as “business as usual at this location”.
   FIG. 13 illustrates the flow.
   A regional or global message may be played to callers before the site-specific message. FIG. 14 illustrates how a system administrator creates such a message.
(9) Stakeholders can access the system via the web or a mini-browser offered by any standard Personal Digital Assistant (PDA) such as a Blackberry or Palm. A stakeholder identifies themselves via Employee ID, home phone number or work phone number. Once identified, the text status information for their site can be displayed by selecting a menu option. If no status message exists, the default message for the organization is displayed.
(10) Reminder messages can be sent by email to stakeholders within a site or group of sites requesting them to update their contact information. These reminders can be created by the system administrator and can be scheduled to go out automatically on a recurring basis (e.g., every month, every three months). The email contains a web link, also known as a Uniform Resource Locator (URL). When clicked, this link brings the stakeholder back to a web page that first authenticates the user and then allows the user to update their contact information.
   FIG. 15 illustrates how a system administrator creates a reminder for stakeholders requesting them to update their contact information.
(11) Personal contacts for each stakeholder may be added via the web interface by individual stakeholders. The number of personal contacts is defined by the system administrator. A web interface allows the stakeholder to enter one or two phone numbers for each personal contact. Once the contacts are entered, the stakeholder can access the system via the phone (typically a toll-free number) and record a voice message. The system then proceeds to deliver that voice message to each personal contact on the list, attempting each phone number to deliver the message. When all communication attempts have been made to the personal contacts, an email report is delivered to the stakeholder that initiated the message. This report shows the success or failure of each attempt to communicate the message to the list of personal contacts.
   FIG. 16 illustrates the flow.
   FIG. 17 illustrates how a stakeholder manages personal contacts.
(12) Documentation related to each site in the Operational Mask can be uploaded to the system. The supported document types include, but are not limited to: PDF, HTML, MS Word, MS Excel and MS PowerPoint. The system indexes the document and provides a web interface for stakeholders to search for documents using Boolean keywords. The stakeholders are given privileges by the system administrator to view documents based on the Operational Mask. The privileges form a security mechanism for access to the documents stored offsite.
   FIG. 18 illustrates the flow.
   FIG. 19 illustrates how ERMS® controls access to documents at site level. In this example, ABC Company has previously given document viewing privileges for Cupertino to the stakeholder. The stakeholder is therefore only able to view documents associated with ABC Company's Cupertino site. Cupertino has a number of documents stored in the repository and the stakeholder has chosen to restrict the Cupertino document list to those documents belonging to the category Floor Plans, a category that was earlier created by ABC Company. ERMS® has returned a single matching document. Clicking the link Cupertino Floor Plans displays the document in the application appropriate for that document (e.g., HTML, Microsoft Word, Adobe PDF).
   Stakeholders can also search the repository for documents by providing keywords to be matched. Boolean keywords such as ‘and’ and ‘or’, can be entered for more complex search criteria. Searches can also be limited to specific sites and document categories.
   FIG. 20 illustrates a sample document search.
(13) Messages can be initiated via the web interface. By selecting a target audience via the web interface, a message can be delivered to that audience. A target audience can be selected by one or a combination of the following methods:
   a. Selecting one or more sites from the Operational Mask
   b. Selecting one or more teams from the Operational Mask
   c. Selecting one or more groups from the Operational Mask
   d. Selecting individuals from the Operational Mask
   e. Selecting an area on a map and capturing all sites within that area
   The target audience can further be refined by removing specific individuals from the list returned by the selection process above. A message is created by typing text into the web interface.
   The message is then delivered to various communications devices defined for each stakeholder on the target audience list. If the message is being delivered to a text-based device such as an email account or a PDA then the message remains in text format. If the message is being delivered to a voice device such as a regular phone or cellular phone then the system converts the text to digitized voice using Text To Speech (TTS) technology. Reports are created and available to the sender on the success or failure of each message delivery to each target recipient.
   FIG. 21 illustrates the real-time flow of messages through ERMS® with corresponding stakeholder authorization checks, confirmations and status reports.
   FIG. 22 illustrates how the target audience for a message can be fine tuned. Sites, teams, groups and/or individuals are selected to form an initial list of individuals. Next, individuals can be removed from or added to this list. In this example, Bill Connors was added as an Individual Addition to the initial list of individuals who were selected from the USA entry of ABC Company's Operational Mask.
(14) Messages can be initiated via the phone interface for the system and targeted at previously defined audiences known as ‘quick-links’. The quick-links can be defined via the web interface and can include a combination of sites, teams, groups or individuals. Up to 10 quick-links can be defined. When the stakeholder dials into the system via a voice call (typically a toll-free number) they must identify themselves and enter a special password (PIN). Once that is completed successfully, the system allows them to select a menu option for initiating an outbound voice call. The stakeholder selects the quick-link from a list presented over the phone and then proceeds to record a voice message which is subsequently delivered to the target quick-link (audience). A report is made available via the web interface to see the success or failure of that message delivery.
   The method of message delivery varies depending on the communication device being used by the message recipient. If the message is being delivered to a voice device such as a regular phone or cellular phone then the system will play the voice message. If the message is being delivered to an email account then the email message will contain a link to the voice wave file. If the message is being delivered to a pager, SMS or fax then the recipient will see a phone number to call and hear the message.
   FIG. 23 and FIG. 24 illustrate the navigation to quick-link messages that were previously created for ABC Company's Boston office.
(15) There are further options for message delivery as defined in feature (13) and feature (14).
   a. If the messages are being delivered to a team or group, they can be sent on a “first to respond” basis. In this scenario, the system will contact the first person on the team/group, then the second person and so on. The process will stop when one of the people successfully receives the message.
   b. The sender can specify that if the primary person on the team/group target audience list does not confirm message receipt then the system should try to contact designated backups for the primary person. The sender can further specify how many backup people should be attempted.
   c. The sender can indicate to a team/group that a conference bridge is available. When the team/group members call the number, they will be connected to the bridge and will be able to speak with each other.
   d. The sender can specify how many communications devices the system should try for each target recipient.
   e. The sender can specify how many minutes to wait between retries of devices for each target recipient and before skipping to the next recipient on the list.
   f. The sender can specify that the system should target the preferred order of communication selected by the recipient, or the sender can actually specify the devices for delivery through the web interface.
   g. The sender can request an explicit confirmation is given by the recipient (usually a Yes/No answer).
   h. The sender can request that the recipient enters a password (PIN) to ensure secure delivery to the proper person.
   FIG. 25 illustrates some of these message delivery options.
   FIG. 28 illustrates the main interface for the management of an event, in this case the Phoenix dust storm.
   FIG. 29 illustrates the current content of the event status report. As the event has only just started, the report only contains two entries.
(16) Certain events take place where an organization would like to account for their stakeholders and employees within a site or group of sites as quickly as possible. The system allows for an event to be created and the system to manage an automated registration process against a specific site or group of sites and the selected stakeholders associated with the sites. There are several steps to the registration process. First, the system allows stakeholders to call into the system (typically via a toll-free number dedicated to that organization) and report the following:
   a. They are ok or not ok
   b. If not ok, optionally leave a message to describe the situation or assistance needed
   c. Enter an emergency contact number where they can be reached
   The system administrator can generate web-based reports for each site showing who has called in and their status, and who has not called in. At any time, the system administrator can generate an outbound call to stakeholders that have not called in. If the stakeholder receives this call in real-time then the system will prompt them for the basic questions (a, b, c—see above). If the stakeholder is not reached in a ‘live’ connection then a message is left requesting the stakeholder to call in and report their status. For each stakeholder, an electronic log file is maintained. Privileged system users can access this log file and enter one or more manual entries to show actions taken by the organization to assist stakeholders. The system allows the privileged users to mark stakeholders as ‘resolved’ to denote that no further action is required on behalf of the organization.
   FIG. 30 illustrates the flow of quickly establishing the status of affected stakeholders following a major event.
   FIG. 31 shows a summary for an event affecting ABC Company's Atlanta office. The company wants to account for its affected stakeholders as quickly as possible and begins by setting up a registration process for them.
   As shown in FIG. 30, the company can decide at any time to initiate a reverse call where any remaining stakeholders who have not yet called in to report their status are requested to do so. FIG. 32 shows six stakeholders who have this ‘No Call’ status.
   FIG. 33 shows a pie chart that breaks down the affected stakeholders in Atlanta into four different statuses.
   FIG. 34 summarizes the contact information for a stakeholder and lists in chronological order any action taken by the company to account for that stakeholder.
(17) Incident Management—An incident such as a theft or an assault occurs often in an organization. Such an event has the potential to escalate to a crisis for the organization. Other examples of an incident include:
   Bomb threat or hoax without an explosion
   Employee termination (with the possible reaction of a threat of violence or a liability insurance claim)
   Technology breakdown
   Telecommunication breakdown
   Computer virus
   Identity theft
   Bad response from the press/media
   ERMS® has an interface to a company's security console to allow the creation of an incident record at source. This record includes date, time, stakeholders involved, nature of incident and other pertinent information. A reporting capability is available via the web to a central management location. Notifications regarding status of incidents are automated.
(18) It is important to track visitors and guests to any site within an organization. ERMS® “Secure Link” allows visitor names to be entered via a web interface for each location. Basic information such as name, company, date, time and employee contact name is captured. The data is stored remotely from the actual site. The data is available in report format should there be a need to account for all people that were in the site at a particular time (see feature (16)).
   For those organizations with an existing security system, an interface between this system and their security badge card system identifies which employees are in/not in the site and their last known location to support search and rescue operation (particularly important for large or complex facilities).
   The system identifies all contractors having badge card access to a site or who may be in a building. These individuals could participate in an accounting for stakeholders during a crisis (see feature (16)).
(19) It is important to track the whereabouts of key stakeholders in an organization. This includes, but is not limited to, high-level executives and people with vital positions or key knowledge about company operations, strategic plans, intellectual property or assets, or those at higher risk of personal/family threat, kidnapping or targeted assassination. ERMS® provides the ability to track the travel schedules, accommodation bookings and itineraries of key stakeholders so that at any point in time they can be pin-pointed on a map. The system also knows the last time they checked in to report their status to an organization's central monitoring console.
(20) For those organizations having or utilizing a travel management system, ERMS® provides an interface so that employees who have logged their travel plans can be tracked and contacted. For those organizations having no access to a travel management system, employees can log their travel plans directly into ERMS®. In either case, the ERMS® “Travel Link” integrates the organization's stakeholders and Operational Mask with a travel system, improving the chances of contacting these people should the need arise.
(21) ERMS® allows for executive protection and support capabilities. This feature incorporates executive personal profiles, family member profiles, security escort profiles, personal identification data (e.g., photographs, scars, fingerprints, voiceprints, dental records, retina scans), home information (physical structure, trees/woods, home security system details), cottages, planes, boats, normal routes to work, children's normal routes to school, recreation patterns, travel patterns and confidential contact information (names of close friends and associates). Rescue and identification processes by the organization or authorities are vital to life safety, protection of a company's image and/or minimizing the impact on shareholder value.
(22) ERMS® provides a template to coordinate and manage all site Business Continuity Management (BCM) plans. Such plans are stored online by ERMS®—see feature (12). This feature maintains an event log and supports status reporting against recovery objectives and the coordination of stakeholder actions and communications.
   When critical events occur, it is essential that the appropriate people be immediately contacted with the up-to-date information pertaining to the crisis. ERMS® is a real-time facility for contingency and business continuity management. In a disaster, if an alternate site becomes unavailable, this information (in the form of an event status report) will find its way to the appropriate BCM leaders. ERMS® maintains up-to-date contact information about key stakeholders required to execute the plan. Critical response actions determined within various BCM plans are auto-linked to ERMS® for in-crisis reporting and corrective response coordination by an organization's Crisis Management Team.
(23) ERMS® provides an interface to a wide variety of public emergency alert systems (e.g., National Weather Service, hurricane centers, municipal public alerting systems, Center for Disease Control) to provide early warning of impending threat or disaster to an organization and key external stakeholders such as customers and critical third-party service providers. ERMS® automatically creates a log of all critical communication details, initiates alert notifications to executives and first responders and immediately determines and disseminates vital impact information as the threat levels change.
(24) ERMS® has an interface to an organization's Closed Circuit Television (CCTV) allowing an incident to be tracked and digitally stored. This allows the organization to maintain a copy of live footage when the original is destroyed or seized. The video footage can be used to provide stakeholders with critical information regarding the status of the site. For details, please see feature (7).
(25) ERMS® can determine the stress level in a user's voice to determine appropriate actions to be taken in a critical situation. Based on the assessment, a notification can be sent.
(26) ERMS® allows an organization to gain location coordinates of its stakeholders by way of GPS (Global Positioning System) devices. Communications can be triggered as stakeholders move in and out of areas deemed to be high-risk by ERMS® agents. Critical in-crisis response teams can also be located quickly as and when coordinated action is necessitated by situation. This feature allows for more accurate recipient targeting with stakeholders during time- and location-sensitive situations. Response to crisis situations may also differ if accurate stakeholder impact data is available.
(27) User access to the system is via the web or phone. Each user can define their preferred language (e.g., English, Spanish, French) and the system will present all menus and options in their language of choice. When messages are created, the sender/creator of the message can define the language of the message.

What is claimed is:

1. A web-based and phone-based emergency management software system operating as an Intuitive Command and Control application comprised of a number of integrated software-driven functional processes, common communications devices and services, and an enterprise database of key emergency-necessitated information; interactively serving an organization's first responders, administrators and agents, emergency management teams and a number of other key internal and external stakeholders, namely
(a) an enterprise database that intuitively reflects an organization's physical structure, logical structure, operational nature, decision making hierarchy and the various relationships between them as an Operational Mask; central to mandated response and control;
(b) a stakeholder database that records identifying, authoritative and contact information on people, vital organizations, services, authorities, regulatory agencies, responders or any party to which an organization may use, direct, inform or participate with in an event or in response to a threat;
(c) aggregation of internally and externally generated information, situational analysis, impact assessment and in-crisis actions taken or contemplated; derived from diverse sources into an event structure of the enterprise database;
(d) functional processes interdependently driven by an organization's authorized system administrators and agents ensuring in-crisis reaction maintains a response focus on life safety, protection of the brand image and minimizing operational disruption;
(e) assigned team and/or software driven event impact assessment, action logs, communication campaigns, rumor management, fact determination, status reporting, stakeholder impact measurement and overall crisis response and control activities; and
(f) secure web based decentralized access to centralized in-crisis response and control within an Operational Command Center environment intuitively integrating enterprise and external vital records, live news broadcasts, active site surveillance, event management, response centers, first responders, impact mapping against the Operational Mask and enterprise database.

2. The system of claim 1 wherein the Operational Mask applies and enforces agent and administrator authorities and privileges against all functionality to maintain confidentiality, privacy, response integrity, data protection and hierarchical in-crisis process reliability through advanced security, identification and authentication techniques, including biometric techniques.

3. The system of claim 1 wherein Intuitive Command and Control presents and displays how an organization will instinctively respond to and manage a crisis situation, threat or high risk circumstance.

4. The system of claim 1 wherein response and reaction triggers, without warning, result in automatic actions, notifications and confirmations and require cause and effect decision making from authorized stakeholders based on the nature, characteristics and impact of an event.

5. The system of claim 1 wherein the system is able to find, track and where appropriate communicate with targeted stakeholders traveling in or near dangerous, exclusion or threatening high-risk zones anywhere in the world;
subsequently informing or directing individuals with appropriate information such as evacuate or take precautionary measures.

6. The system of claim 1 wherein the integration of various facility card and other access control systems or security systems are automated to determine current populations of employees, contractors, visitors or any other stakeholders on-site and where interface allows, whereabouts of found individuals.

7. The system of claim 1 wherein the individuals at high risk and sheltered by the organization's executive protection program are reactively identified to initiate communications and direct protective actions determined by the event, impact and probable outcomes.

8. The system of claim 1 wherein physical locations/sites (entities) within an organization's Operational Mask are described in a textual, graphical and pictorial manner, resulting in extensive operational-use profiling thereby ensuring company and authorities are fully prepared to enter, protect or otherwise respond to a threat to a physical entity.

9. The system of claim 1 wherein public alert notifications received from various external authorities and agencies are integrated providing situational updates, warnings or response instructions resulting from an event or threatening situation that puts physical entities or stakeholders within the Operational Mask at risk.

10. The system of claim 1 wherein video imagery from closed circuit television surveillance systems is integrated to permit a response to events that are in progress and threaten life safety or the operational status of the company.

11. The system of claim 1 wherein its integration with Business Continuity Management (BCM) software tools ensures critical processes in contingency or recovery mode are applied against the Operational Mask providing an enterprise wide view of all in-crisis response and control activities, disseminated in a consistent and time-sensitive manner.

12. The system of claim 1 wherein the current location of key stakeholders, such as executives, subject matter experts and critical response teams, is achieved through advanced satellite tracking of cell-phone or PDA devices to direct, support or communicate vital in-crisis information.

13. The system of claim 1 wherein GIS based mapping technologies integrate positioning of physical entities against system generated geographic world maps to interactively identify zones of impact and corresponding entities impacted by or threatened by current, probable or possible events; as well as access restrictive no-go and exclusion zones.

14. The system of claim 1 wherein organizational priorities related to life safety are addressed through a series of ‘registrar’ type processes; whereby the system is interactively used to account for or search for various stakeholders that may be impacted by an event

15. The system of claim 1 wherein various stakeholders obtain site-status related information or instructions and gain access to functionality of the system through common services such as ‘hotline/business resumption line’, PDA and secure web access.

16. The system of claim 1 wherein individual stakeholders can utilize the software to disseminate a ‘personal emergency’ message to multiple personal contacts self maintained by the individual in a personal section of the stakeholder database.

17. The system of claim 1 wherein critical in-crisis or emergency response documents (reports, plans, vital information), are secured and accessible through ‘hotdocs’ functionality of the system to individuals with granted privileges to view the documents related to defined areas of the Operational Mask.
